(19) United States
(12) Patent Application Publication
(10) Pub. No.: US 2007/0255702 A1
(43) Pub. Date: Nov. 1, 2007

(54) Search Engine

(76) Inventor: Gregory Michael Orme, Lavergne, TN (US)

Correspondence Address: Gregory Michael Orme, 310 Oakwood Cove, Lavergne, TN, 37086-4130, US

(21) Appl. No.: 11/563,691

(22) Filed: Nov. 28, 2006

(30) Foreign Application Priority Data
Nov. 29, 2005 (AU) 2005906646
Nov. 28, 2006 (AU) 2006902171
Oct. 3, 2006 (AU) 2006905449
Nov. 27, 2006 (AU) NPS RCPT 74035115

(51) Int. Cl. G06F 17/30

(52) U.S. Cl. 707/5

(57) ABSTRACT

A preferred embodiment comprises the use of search rankings referring to a data object according to different sets of key words. So a search result according to a first set of key words might have a first ranking in a search result. The same data object including such as web pages and the like might have a second ranking if a second set of search words was used. The data object might appear in search results using a plurality of sets of key words and so when using the first set, also knowing the ranking from using the second set gives more information about the data object.

Australian provisional applications 2005906646, 2006902171, 2006905449, and Australian provisional lodged Nov. 27, 2006 NPS receipt 74035115 are incorporated by reference.

### BACKGROUND OF THE INVENTION

The invention relates generally to software and more particularly to search engines.

### BRIEF SUMMARY OF THE INVENTION

One problem with search results is that it is often difficult to find relevant material on the web pages in the search results. A preferred embodiment includes a means to compare rankings of a data object with different search key words and thus includes to provide a searcher with other key words to use.

### DETAILED DESCRIPTION OF THE INVENTION

In a preferred embodiment there is preferably included in a plurality of search results (which is typically a hyperlink) an means to go to a particular part of a web page.

The invention is intended to be not limited to the internet but to be used on any computer, network, communications device. For example web page can include those used on any computer, network, mobile phone, etc. It can also be considered to include any page of data including using a file manager, FTP program, window in an operating system, desktop in an operating system or program, menu in a program, etc.

For example a hyperlink can include in its code a means to go to a particular line, position, etc on a web page. If this was included in search results then a user clicking on the link would see a section of the web page referring to his search criteria e.g. key words.

In a preferred embodiment a search engine provides to a user results with said means for directing the user to a particular part of a web page.

For example the search results could be displayed on a web page with frames. A first frame might include the search results preferably in a list, and associated with a first link result that has multiple instances, examples, etc of the desired search content on it (including for example where the key words occur in multiple places on a web page, etc) are included a second set of links each with preferably a more specific link to a section of a web page relating to the search including for example sections with the key words in them, at least one additional link placed into the web page or pages that the first link or the second set of links leads to (including for example where other links to try are placed into the first link e.g. so that a user can go from a first search result to a second search result without having to go back to the search results page. For example a web page brought up by the first link might have the next 3 links (or any number) in the search list in it, at the top, in a frame, in a pop up, in a pop under, in a banner, etc so the user can click on them), etc.

A second frame preferably contains other search results according to categories, classifications, etc. For example a first category might be commercial sites, a second category might be blogs and forums, a third category might be private sites, a fourth category might be reference sites e.g. encyclopedias or dictionaries, a fifth category might be location based e.g. results according to what country, state, down, suburb, etc they are in, etc.

Of course these categories are not intended to limit but to illustrate that any categories suitable to the search results can be used.

For example if a user clicks onto a category in the second frame then in the first frame is preferably displayed links e.g. search results in that category.

For example a user might click on a first category e.g. commercial sites and in the first frame would be displayed search results that were shops, online stores, etc.

In another example a user might click on a forum category which could include forums, blogs, etc that mention the search criteria e.g. key words, but also a forum or blog that discussed those key words or search criteria.

For example a user might input “NASCAR driver” into a search and a forum category might include inputs from users who made comments, posts, suggested links, etc relating to these key words.

Preferably the forum or blog would include comments by user including for example how good their search results were, still looking for a suitable search result, suggestions for others using those key words, suggesting other key words to try, suggesting links to try, etc.

In a preferred embodiment said blog or forum could be moderated, managed, etc by a user including for example an employee of a search engine or related company, a private individual, an organization, etc.

For example a user might manage an Internet or other network presence including for example web site, forum, blog, chat room, file repository, etc that relates to those key words or other search criteria.

For example a user might receive regular traffic from users inputting a certain set of search criteria and the user might in return attempt to assist these users.

Preferably the user or the search engine can advertise on this web presence in a certain ratio of profits between the user and the search engine. For example a user might receive a consideration including for example a fee for advertisements that are clicked on by users of the site, a fee for each user that visits the site, a fee for each user that buys something through a link on the site, reduced hosting costs, free hosting, storage space for reduced costs or fees, commissions, salary, etc.

In another example a first user running a said first web presence might communicate with a second user running a second web presence and work together to improve their sites.

For example a first user might look for other sites that are useful for the people that visit his sites, so as to offer a better service and include on his site useful data including for example links (e.g. to dictionaries, encyclopedias, related web sites, shops, other forums, etc), images, advice, at least one other forum e.g. for general discussions, discussions on sub categories related to the search criteria, etc.

The invention relates generally to search engines and more particularly to improving search results.

Preferably there is a means to monitor, check, audit, etc search results by adding and removing key words.

Searching on the Internet, desktop searching, database searching, etc often has problems in displaying desirable search results to a user.

Often this is because many web sites, documents on a server or computer, etc are not written, designed, optimized, etc for those particular search criteria e.g. key words the user inputs.

The solution includes determining how data sources including for example web sites, FTP sites, files, documents, folders, etc are focused, optimized for, etc particular subjects, key words, categories, classifications, etc.

For example if a user inputs certain key words they are likely to be for a search result focused on those terms. Usually a data source e.g. web site, etc that has data on many subjects, key words, etc is likely to not have detailed data on the particular key words the user inputs.

Preferably the search engine can try different word combinations to monitor, check, etc the rankings of different sites.

For example the search engine might be checked with a particular first set of key words e.g. “NASCAR driver”, and the search results are checked. The first set can be for example be broadened including for removing at least one key word from the exampled first set and comparing that search result with the first set.

Typically this will give a broader, less focused search result. For example taking one word from the first site might make a second set of e.g. “NASCAR”.

Preferably a first search result is compared if it is returned using the first and second set. For example if a web site rates highly e.g. is high on the list of results for the first set and then is also highly rated on using the second set then one might suspect the first search result is more about NASCAR in general than NSACAR drivers.

In a preferred embodiment a search engine has different combinations or sets of key words for analyzing. Typically these sets might contain 1, 2, 3, 4, 5, etc or any number of key words.

Preferably each of these are checked by removing e.g. one or more key words from each set and seeing how results of the search change as the key words are removed.

Preferably as before results e.g. like the first search results are flagged, noted, listed, etc as e.g. indicating those search results are not focused on certain sets of key words even though they might rate highly in some algorithms e.g. Page Rank.

For example Page Rank or another algorithm might rate a site that is linked to a lot about NASCAR, and also rates highly about NASCAR drivers, even though people link to it mainly because of NASCAR in general not the drivers.

Preferably the search engine analysis would be looking for a first result that ranked highly say under the first set “NASCAR drivers” and lower under “NASCAR” because this would indicate it was a less desirable site for NASCAR in general and much better for enquiring about the drivers.

In a preferred embodiment results of this analysis can be made available including for example in a forum, in a blog, by contacting the web site (including for example the webmaster, registered owner of the domain, email address on the web site, email address on the web site, address on the web site, phone number on the web site, etc).

Preferably the availability of this analysis can be used so that data sources e.g. web sites can be adjusted, modified, edited, etc to improve them in search results according to a particular algorithm.

The invention of contacting data sources, creating new data sources, modifying existing data sources, etc according to a search algorithm is not intended to be limited to the said analysis (including for example of adding and removing key words from sets and analyzing the results, etc) but the said algorithms and analysis herein are intended to illustrate that a search engine can improve its search results not only by improving its search algorithms but by determining where search results can be improved and creating, modifying, persuading site administrators, etc to improve these data sources which improves the search results.

For example all algorithms in search engines can determine which areas, key words, subjects, etc are not returning optimum results and they can typically determine what an optimum result should include in e.g. information, sales outlet, shop, club, forum, blog, news, encyclopedia, etc.

By the steps of e.g. determining these sub optimum results, determining what optimum results would be like, creating the optimum results by altering existing data sources or creating new ones, analyzing the newer data sources to determine if they are still sub optimum or not, search results can be made more consistent, reliable, etc.

In another example users can complain including for example in a blog, forum, email, messaging means, etc about certain sets of key words which can then be determined if they are sub optimum in results and the data sources can be as said improved, replaced, etc.

In a preferred embodiment not only can at least one key word from a set be removed to check the search results, but at least one key word can be added to see how the search results change.

For example a first set of key words e.g. “NASCAR driver” might be analyzed by adding key words.

Preferably these additional key words can be determined according to an algorithm.

For example search results with the first set might be analyzed and key words taken from them. In another example key words might be taken from reference and other sources including for example encyclopedias, Wiki, dictionary, thesaurus, sites specializing in a subject, etc.

For example a Wiki entry on NASCAR drivers might give key words including for example their names, and other key words with less focus e.g. the cars.

Preferably classification of topics, key words, etc can be determined including for example in tree form, in root of a tree form, etc.

Preferably said key words are added to sets of other key words. For example the first set “NASCAR driver” might have a first group of key words to add onto the said first set.

Preferably the first group as an example here for illustration is composed of key words from any source and the sources described here.

For example key words in the first group can be applied to the exampled first set so that all possible permutations and combinations are analysed.

For example each key word from the first group is tried with the first set, then each combination of two words from the first group is tried with the first set, then each combination of three words, etc.

For example with the first set example “NASCAR drivers” the first group is likely to contain the names of each driver, and those results are analyzed. It might also contain the names of all the sponsors of NASCAR and those results are analyzed. It might analyze then, in any order pairs of words and pair e.g. a driver's name with a sponsor's name with the first set key words.

Preferably the results are analyzed including by the algorithms disclosed herein, or by any other algorithm.

Preferably the results are used to determine if some search results are too unfocused on the key words, or if in any other criteria they are sub optimum.

Preferably the search results can be optimized also by adjusting, modifying, etc search results.

For example if sub optimum results are found by the said analysis then it may also indicate that some results are rating too highly.

For example with the said first set key words were removed and added in all possible combinations and permutations, but this can also be extended to show results moving from one focus, key word set, subject, classification, etc to another.

For example on adding key words to the first set one might analyze results of e.g. “NASCAR drivers” and different driver names, racetrack names, sponsor names etc.

Preferably one can then use a method of removing key words but also removing key words from the first set, so the results tend to broaden in focus again, but away from the first set key words.

For example removing “drivers” but retaining say 4 extra key words that were added e.g. 2 driver names, a sponsor name, a racetrack name, (all these words and set contents are examples for illustration not limitation) would give results that might have less focus on drivers in general and more on e.g. those 2 drivers, their relationship to a given sponsor, a racetrack, etc.

Preferably by this process of adding and removing key words and analyzing the search results and other factors one can determine which data sources are best for certain subjects, key words, etc.

For example there might be a site that is not useful for NASCAR but happens to mention it e.g. in a blog story and people comment in general terms.

Results like this might not contain much information but could be classified as forums because search terms like blog, forum, chat, etc can be added e.g. like in the first group to see which search results change, and preferably types of results can be determined.

For example forums of various kinds can be determined and might be removed from search results unless a user asks for them.

In another example shops might be found by using key words in the first group like e.g. sale, shopping cart, price, etc and these might be removed from the search results, marked as commercial sites, be displayed more prominently if the user asks for commercial sites, etc.

In another example any first set of key words might have any kinds of other key words added to the said first group including for example racist language to find hate sites, warez terminology to find hackers, dates to determine how old the data is or what events it refers to, names of people to determine who the site is talking about, names of towns or other locations to determine what areas they cover or are interested in, religious terminology to find religious sites, swear words and pornography terms to find sites unsuitable for children, etc and these search results can be analyzed and actions taken including those disclosed.

In another example a search result might display classifications of e.g. links, documents, etc according to their type, date, a business, and all other classifications disclosed herein.

Preferably a user might see these classification displayed including for example in a tree format, in a root structure, as multiple choice questions to select options, etc and thus can select which area, subject, etc he is most interested in.

Preferably the analyzing means can determine details of a data source including for example making a report on it, making an abstract of it, making a list of its relevant key words, suggesting other data sources e.g. web sites which could be examined (including e.g. other sites agreeing with it, other sites disagreeing with it, other sites having businesses associated with it, other sites with more broad coverage of aspects of the web site, other sites with more detailed coverage of more narrow aspects of the data source, etc), etc.

Preferably data sources can be updated, modified, created, etc with data to improve search results as disclosed herein, but also a connection means including for example links, recommendations, commentary, abstracts, etc can be added to them, suggested to owners and administrators of the data sources, etc.

For example an administrator of a web site might be contacted with suggestions on how to improve the data for the search engine, which links to add, which links to remove, which advertisements to add, what subjects to write on, what subjects to remove, a list of other sites that have similar or opposing data and suggestions to e.g. avoid duplication or compete with their information, etc and these changes can be submitted to the search engine and the changes in the said search results determined.

For example an administrator of a data source e.g. web site might modify his data a plurality of times and see how those changes improve his rating in search results.

In another example a document might be requested to be rewritten with suggestions from a search engine on a computer or network, to add links or images, etc to better cover a particular subject.

For example documents, files, etc might be in a database and search results might indicate some files should be modified in their data to focus more or less on various subjects e.g. to avoid duplication, to cover an area which the database has a sup optimal amount of information on, etc.

In a preferred embodiment advertisers might analyze the said results to determine which data sources e.g. web sites might be best for their products. For example an advertiser selling products sponsoring a NASCAR driver might be able to find those sites best focused on him, and the communication with people associated with a web site might also include advertising offers as those sites might have more people interested in those products.

Preferably a search engine could also have code to include on a web site that was activated each time someone opened the web page, and so they could determine how often it was visited. This could include for example advertisements, hit counter, banner, logo e.g. of web site, etc. For example each time a user opens a web page data including for example an image, counter, etc is downloaded from the search engine or an entity associated with them and this is recorded e.g. as a hit or visit.

In another example a slow downloading segment of data could be sent when a user opens a web page and if this download is interrupted it is known that a user left the site and this how long he stayed.

Computers work together to work out search of sites visited and put together processing of this with central server.

According to at least one invention a plurality of computing means (including for example mobile phones, laptops, smart phones, Personal Digital Assistants, desktop computers, mainframes, web servers, embedded circuitry, software, virtual machines, distributed networks, car computers, anything with computer circuitry, etc) are networked together (in a communication means including for example the Internet, a LAN, wireless, Bluetooth, mobile phone signals, phone lines, wires, network protocols, pervasive computing, optic fibre, etc) containing data files.

Preferably said network is of a distributed computing type.

Preferably searching for selected data on said network is done by distributing search terms amongst said computing means.

In a preferred embodiment each computing means in said network contains data which needs to be indexed for searching.

Preferably each computing means indexes data on itself, and creates at least one first index file.

Preferably a first group of said computing means indexes said first indexes on each computing means in said first group, called the second index.

Preferably a second group contains a plurality of said first groups, and an index of at least part of the said first indexes, called here the second index.

Preferably said indexing continues in this method with each group containing sub groups in a tree structure with the branches usually ending at the computing means first indexes.

Preferably said computing means and groups contain redundant data including for example multiple copies of data on a computing means (including for example in storage, on a hard drive, in RAM, on an optical disk, in remote storage, on tape, etc), checksum data to reconstruct lost data, copies of data from a first computing means is kept on a second computing means in a storage means disclosed herein, etc.

In a preferred embodiment said indexing can be in a format including for example certain computing means might contain data starting with a certain letter, of a certain popularity, of a certain type (including for example movies, music, books, search, etc), of a certain hash, of certain owners of said data, etc.

Preferably searches can be made of said computing means to locate data, which can be transferred from a first computing means to a second computing means as disclosed herein.

Preferably said search can be distributed including for example passed, replicated, transferred, copied, etc from a first computing means to a second computing means, from a first group to a second group, etc until a preferred copy of said data is found.

For example there may be multiple copies of said data so it may be preferable to search for a copy in a suitable location with characteristics including for example near the sender of the search, with a cheaper cost to do the search and/or transfer said data, with a faster transference of said data, with a more error free path to transfer said data, where said copy is more immediately available e.g. when a copy might be stored and needs to be retrieved (including for example remote storage, optical disks, hard drives, tapes, etc)

Preferably on receiving said search request said computing means searches its index, and also any indexes it might manage for said groups.

Preferably said computing means can transfer data from a first computing means to a second computing means, updating indexes so as to assist in more efficient search patterns. For example more popular data might be more easily found, be easier to retrieve, be cheaper to retrieve, etc.

Preferably selected computing means might contain more complete indexes and hints as to the location of said data by criteria including for example a faster computer, a faster network, computer location, computer availability, etc.

Preferably said data is substantially unavailable to the user, owner, etc of a first computing means by a means including encrypting it, having only unusable segments of said data, hiding it, denying access to it (e.g. with Access Control Lists, etc), etc.

Preferably searches are directed to at least one computing means as a starting point for searches. For example a search might be classified (including for example as movies, TV shows, books, music, programs, code, statistics, etc)and according to that classification go to a selected computing means.

Preferably said computing means include a list of other computing means to forward unresolved searches to.

According to at least one invention there is a manipulation means including for example to search data, display data, do anything that occurs in a computer operating system and programs that run on one, etc on a computing means (including for example a computer, a laptop, a Personal Digital Assistant, a mobile phone, a desktop computer, the Internet, a network, a distributed computer network, etc).

In a preferred embodiment a user of said computing means has an analysis means e.g. ask him questions from software regarding what he wants to do, or it can guide him, give hints, etc.

For example if he wishes to make a search he is preferably asked questions about said search, and preferably alternative answers are disclosed with a communication means including e.g. the user seeing, hearing, otherwise finding out about them.

Preferably said analysis means using an artificially intelligent program including for example like the Eliza program.

Preferably said program can draw on user data to determine what questions to ask next (including for example to use what the user says, types, gestures, etc to compose another statement, query, etc. Said analysis means can also use other data including for example from searches, user's profile, user's file, user's email, user's messages, user's phone conversation e.g. on VoIP, user's documents, etc to determine what statements or questions to ask next), what results to display, what actions to perform (including for example shut down, restart, connect to the Internet, connect to a particular storage means [including for example web site, database, search engine, file repository, forum, blog, etc].

For example a user wants to search about a particular subject say NASCAR drivers using a certain kind of car part. Normally a search like this would be a big problem to make because such data is often fragmented.

The said analysis means then can use e.g. questions drawn from said data sources to do the search, make an order, or do any action said user wants. Searching is an example here for any computer function.

Preferably said analysis means might ask why the user wants to know, and from the answer narrow said search, work out further questions, etc.

Preferably said analysis means might refer to said other data. For example it might find other references to this in said user's previous searches, browsing history, emails, files, etc and ask if certain parts of said data are relevant and whether said user was successful or not.

Preferably said user can answer and direct said analysis means with speech recognition, including for example if said analysis means offers alternate answers (including e.g. multiple choice options, etc) said user can answer from them, which preferably are designed by said computing means so said options are phrased in a format easier for the computing means to understand. For example if each option sounds different enough from the others then said computing means is less likely to make a mistake.

Preferably said analysis means can store information from interactions with said user for later use (including for example to ask questions later, etc), and including for example to use in searches, indexing, database structuring, etc.

Preferably said analysis means can offer search results and if said user offers feedback e.g. rejects them, queries them, accepts them, etc then said analysis means can frame further questions (preferably for example based on the wording, context, etc from said user's responses, said searches, said user's previous history and communications, etc) including for example were said results of any relevance, how did they score e.g. hot or cold, scale of 1 to 10, etc, was the search understood, was it the right type of search result (including for example a shop, an encyclopaedia or wiki result, a privately run site on e.g. at least one search term, etc.

Preferably said analysis means can take said feedback from said user and factor this into said search. For example if said user says the results are a long way off e.g. “cold” then said analysis means might look for more different results.

In a preferred embodiment said analysis means and/or user can post said search queries, questions, etc in at least one interaction means including for example a blog, a forum, a chat room, a mailing list, a portal, phone conversations (including for example where said computing means can say questions, etc said analysis means intends, etc), etc.

Preferably other users, other analysis means, other programs, etc can also converse including for example post, ask questions, give suggestions, comment, etc in said interaction means.

Preferably said analysis means can present search results and other actions based on classifications in ways including for example options for search, different types of search results (including for example online stores, forums, previous messages, user sent or received, databases, encyclopaedias, etc), clusters of search results of a similar nature to other search results in said cluster are placed together, etc.

Preferably said analysis means can prepare said responses including for example acquiring, downloading, collating, etc said data for said user so said user can examine it offline.

Preferably said results can be displayed in a tree structure.

Preferably said search results can be graphically linked to each other including for example with lines e.g. colored, links e.g. hyperlinks, arrows e.g. flowcharts, punctuation e.g. question marks or exclamation marks, etc.

Preferably said search results can be displayed according to algorithms including for example Google, Yahoo algorithms, Microsoft, etc.

Preferably results can include results for other users according to permissions given by the first user. For example if another user searched similar terms one could see their results, and which ones they selected.

Preferably there is a zoom function associated with said results, particularly in said tree form. For example at a certain level results could be mixed together, and as one zooms in results become separated into different clusters, types, classifications, etc.

Preferably results are displayed with the preferred results including for example the ones the analysis means considers are most likely to be useful are placed substantially in the center, and radiating out from these are other results classified into types, each type with its own branch (preferably branches are graphically represented e.g. with arrows, lines, etc), and then each type preferably has sub types branching out from it, etc. Of course the best results need not be in the center, they could be at the bottom, the top, the side, etc with other results still radiating out from them as disclosed.

In a preferred embodiment associated data including for example search history, personal data files (including e.g. email, messaging service files such as Microsoft Messenger, etc, personal and other documents, down loaded files, contacts, etc) can be used for a computing means to provide related data.

Preferably the related data substantially is used to exclude results including for example in search results, advertising, etc. For example a software means determines from a user's said associated data what they might be interested in. Preferably said associated data might then be used to provide said search history customization, advertising in emails or other messaging services (including for example VoIP, web pages e.g. according to cookie data different advertisements or articles might be shown, mobile phone service where a cheaper or free call is given including for a user listening to ads played in the call [including e.g. at the beginning of the call, the end, at predetermined times, when a quieter part of the call occurs e.g. when people stop talking or talk less, according to recognized content e.g. when key words or recognized in the call and advertising related to it is played <this advertising means of course can be used with any communication means known in the art, all of which are claimed>, etc], any use known in the art where a user history on a computer, phone, buying patterns e.g. credit card use is able to be analysed and a service e.g. advertising can be provided in relation to such advertising.

Preferably the said associated data e.g. search history, etc is also used substantially in a negative way, including for example that where said associated data indicates a user is less interested in a first set of data that first set is provided less to the user.

For example a user might through search history be determined to be interested in a first set of search results e.g. links for a first set of key words. The user might select certain links and these links might be used according to an algorithm that they are more useful, and so they might be presented more highly to that user, and to other users according to those key words.

Preferably also the links the user did not explore can be taken to indicate those links were less valuable to that user and might be less valuable to other users. For example links that were rarely selected might be determined according to an algorithm to be less popular and so might move lower in ranking in various search results.

In another example advertisements directed in response to a user's associated data and not clicked on, read, followed by a user might be determined according to an algorithm to be less interesting to them, and such advertisements might then be replaced with others that even though there is less information to determine the user might be interested.

For example a user might read web sites about NASCAR racing and discuss it in emails, on VoIP, and consequently advertising might be targeted on this in his emails, advertising like e.g. AdSense might show ads according to those key words and so on.

However the user might be interested in the subject, but not in buying anything in relation to NASCAR so such advertising might be wasted since his lock of response to said advertising, search results, etc is not taken in account to determine what advertising to show him in the future.

In another example a web site might have advertisements directed to associated data including for example the content of the text on the web site (including e.g. where key words on a web site that relate to the product might determine according to an algorithm to place advertisements associated with those key words there, and e.g. auction off the placement of those key words to advertisers. However it is not really known that because the user is reading a web site with those words, saying words on a VoIP or other phone call, writing certain words in an email or other messaging means, etc that he wants to buy anything about them. For example he might be writing or saying he hates those products.

Preferably then through an algorithm the success rate of said contextual advertising, search histories, etc can be monitored for their success, and according to an algorithm if said success is below a certain level then less used key words in the e.g. web site, phone call, email, etc might be evaluated and advertising, search results, etc according to them displayed. Also if applicable key words substantially opposite the meaning of words in the email, phone call, web site, etc might be evaluated according to an algorithm and advertising search results, etc provided to see whether they result in a user e.g. clicking on ads or otherwise responding to them.

For example different advertising, etc could be tried as disclosed and results compared e.g. according to an algorithm so that the user's real need to e.g. buy something can be determined, even though it may seem less likely because of said key words in said communications, web sites, search enquiries, etc.

In a preferred embodiment search results that are rarely selected might be moved lower in ranking than such non selection might indicate if the statistics of link selection are viewed in terms of popularity. For example a search result might persistently come up in results e.g. because in Page Rank a lot of sites link to it, but searchers rarely want to find it. If such nonselection is monitored according to an algorithm, sites such as these might be dropped much lower in ranking to see if searchers find the results they see more useful.

In another example blogs, forum posts, etc might appear in search results and while fulfilling search criteria and certain algorithms few people are interested, so dropping such results much lower in ranking for a trial might determine how useful it is to show those results to users.

In another example a first search result with a certain lower level of selection for a first set of users with a first search history might be dropped lower in ranking but not to a second set of users who might select that first result more often, above a certain level of times, etc.

Preferably this can eliminate a lot of unwanted links, which any other kind of algorithm might be unable to determine are less wanted. Preferably such lowering of rank can be a time period according to an algorithm and then raised again, so it can be seen if said low selection rate is a temporary factor, the lowered ranking causes a web site creator to improve his site, whether there are seasonal or other variable factors as to why the site is less popular, etc.

In a preferred embodiment a link can be indicated by a user to be less desirable including for example clicking on it with a mouse, clicking on a menu item accessed with a right hand mouse button, hitting a key on a keyboard, etc and said indication might determine according to an algorithm similar results to this be placed less highly in a result, be lowered in ranking, be not shown to that user, etc.

In a preferred embodiment links on a site, information in or on a metalink advertising layout, text layout on a web page, email and other communications sent to the user might according to an algorithm avoid more the indications the user gave that he was less interested in something by any of the means disclosed herein.

According to an invention there is a means to improve search engines and advertising revenue.

In a preferred embodiment users and/or computers bid for ads that are relating to the links, web pages, documents, etc that appear in the search results not just the keywords themselves. So for example a given set of keywords in a search engine preferably gives a list of results so users bid directly on relating to those links.

For example a company wants to bid for advertising, so they initially might look at preferred keywords and what web pages and other urls are returned by them by the searching means, e.g. a search engine. They preferably then select which links including for example web pages, PDF files, documents, MP3 files, images, DOC files, programs, etc most suit their preferred criteria to have their advertising near. For example if they are selling boats they might like to have web pages that refer to boat hobbyists near their advertising, but don't wish to pay for ads next to rival's web pages if they come up on the search, especially if their prices are cheaper. Such ads might be wasted.

Preferably the advertisers select preferred web pages that might come up based on predetermined search algorithms, and pay on the basis of those links, web pages, etc that come up. For example they might have a preferred set of say 10 web sites they would pay a negotiated amount to have their ads on the same page with. Preferably the higher those links, pages, etc come on the search results page the more the advertiser might pay to have their ad on that search results page. For example they might pay more to have their ad in a preferred position regarding certain links.

In a preferred embodiment search results might be arranged so as to appear near preferred advertisements. For example say there were 10 links the advertisers were prepared to pay to have their ads near. The top link might have an ad directly above it, to the side, it might appear in an excerpt from the web site, etc and any other position the advertisers might negotiate to have. In another example a link might contain excerpts from the page set out in a preferred format and the ads situated in or near those excerpts so it appears to be structured by design, perhaps like a web page itself. This might be set in a frame for example.

In a preferred embodiment search results can be return in a web page with at least 2 frames. Preferably each search result might appear in its own frame so initially for example the user might see each result in a smaller format and by expanding frames he can see more and more of each result, perhaps even showing the whole web page in the frame. Advertisements can be displayed in this example of a frame, and they can be charged according to the format and how well it displays their advertisements.

So an advertiser might pay according to criteria including how well their ad is shown in relation to links they approve of, and how far away from links they disapprove of. In another example if a link they don't like, e.g. that of a competitor appears in a result they might pay to have their ad in a position above the undesirable link so the user might not get to the undesirable link. Advertisements can include any format known in the art for example flash, pop ups, images, animated gifs, banners, etc.

If a preferred set of key words were selected by the user and the desired search results, links, web pages, etc (the ones the advertisers prefer) came for example lower down in the results page, on page two or later pages of the search, etc the advertiser might still elect to have their ad shown but preferably at a lesser cost because fewer users might go to those pages.

Preferably if none of their preferred links, results, web sites, etc are featured prominently in the search results from the predetermined key words, then according to the policy of the searching means they might receive a cheaper rate, not have their ad appear at all, have it appear for free, etc.

Preferably the advertisers might have an arrangement with those web sites they like and/or have selected to be part of their criteria for advertising payment, so that for example if a user gets their web site in the search results they might have the advertiser's ads displayed. For example the user might see a link they prefer, which the advertisers have selected as part of the criteria in their advertising. Their ads might appear on the results page in a way preferably that shows this web site in a favourable light, at least in relation to at least one advertisement. They would then like for users who go to this web site to see more of their advertising, and preferably for the web site to assist in the user clicking on one of their ads or otherwise using the advertiser's products or services.

In a preferred embodiment an identifying means including for example a cookie might be placed in the user's computer, data added to the link to the web site selected, a notification to the web site administrator, a notice to the advertiser, etc so when the user goes to the web page this is monitored, known about, logged, etc and acted upon in ways including for example the at least one of the advertiser's ads show to the user, it is recorded that there was a visit there by the user, that the search page referred the user to that web site, the time the user browsed there, etc. If the user finds his way to that page in another way, and/or after a predetermined time period the advertiser might not want to pay to have his ads there, so he might prefer to only have his ads show according to his criteria, including for example when people come from preferred places, when people come after having first seen their ad, when a user visits with a predetermine amount of time, etc. Preferably the advertiser can examine this data and determine the most effective criteria for his advertising budget.

Preferably if the user goes to at least one of the web sites from the search at least one advertisement from the company might be designed to appear. The e.g. server that monitors which ads are displayed, downloaded, tracked, etc related to a certain web page might note for example that an advertisement was downloaded onto that web page and/or to the user with a predetermined time period after to a search engine result displayed that link. The searching means and/or the advertisers might preferably conclude a user visited there from the search engine results with a degree of certainty or probability and base their payments on that criterion. The advertising company and searching means might negotiate a payment or some other agreement between them for this success at showing their advertisements to a user from the search engine page.

For example a server might download advertisements onto a search engine results page, and/or the search engine might note which ads appear on what search results. At this point then the searching means and advertisers can tell a user's behaviour to some degree. For example the ads on a search result or other web page might download the text, images, flash, etc for those ads from at least one server rather than the searching means or web page having to have the advertising files stored by themselves. Since the files are downloaded it can be logged when this occurred. It can also be noted if the download did not complete so this would imply the user did not stay on the page long enough. For example say an ad takes a minute to download parts but other parts download more quickly. The advertiser might be able to tell the user left the page in less than a minute because the download did not complete, and preferably pay less because of this

These can be correlated with ads that appear on web pages so for example if these downloads to a search results page and a web page featured on it both occurred within a predetermined space of time it might be deduced that the user probably went from the search results to a web page that showed the ads. This result might preferably be paid for by the advertiser, for example as being like a pay per click with a negotiated payment agreement.

Preferably the web pages listed in the search results can also have ads generated for the advertisers so when the user goes to the web page they see ads related to those from the search results. This can also be paid for by the advertisers. For example when the advertiser selects key words, and web sites he prefers his ads to be near he or others might approach the web site administrator to advertise there as well. He might also have a means to get data on users of the site including for example what web page referred them. This data is often collected in web statistics programs.

In a preferred embodiment the search engine might have cached information of data pages including for example web pages, PDF files, images, advertisements, other data files, etc listed in the search results and could show a certain amount that cached data to the user along with preferably advertisements arranged from the advertisers.

For example often with a Google search result web pages are cached, and PDF files converted to HTML for display. A searching means could used this cached data to show the user a web page with advertising, text, data, images, flash, etc different from at least part of the original data page including for example the original web page, and preferably charge the advertisers for this.

Preferably it could also show the cached data as a web page and receive payment from at least one of the advertisers on the original web page since it is the search engine means displaying the data not the original web page. Preferably it could act as a host for web pages and other data, preferably charging for this in ways including for example like a hoster of web pages would. For example a host company Optus would host web pages for a fee but the searching means could also charge a fee for this cached material when it is displayed, at a monthly or yearly fee, a fee per bandwidth used, a fee per number of hits, etc. They might expand the cache and otherwise have more data on hand including for example any services a web hoster would have.

Preferably there are many variations on this broad concept. For example the searching means, the original web page owner and other interested parties e.g. advertisers, advertising agents, spy ware makes and users, host company for the data pages including for example at least one web page, etc might agree to a negotiated split of the advertising revenue. For example the search engine and the web page owner might agree to each receive half of the advertising or other revenue including sales generated from it when the searching means displayed the web page from its cache though any ratio of splitting the revenue can be decided by the parties concerned.

In a preferred embodiment this may be a good arrangement for the web page owner because it lowers their cost of bandwidth if the user sees the data files, PDF files, web pages, etc partially or wholly from the search engine cache instead of in addition to the original, and the search engine can preferably get revenue from the ads it places, preferably removing perhaps other ads from the original as it does so. The searching means might use any advertising method known to the art to include with the cached data comprising for example pop ups, flash, images, links, java, spy ware, etc.

Preferably the search engine using its cache and any other data storage can also show ads from the original web site if it prefers, or perhaps under an agreement with the site owner it can be negotiated which ads will be displayed. The advertisers on the original e.g. web page can perhaps be charged on the basis for example that the user came from the search engine and did see their ads just as if he had gone to the original site. The advertisers might then pay a predetermined and/or negotiated ratio according to criteria associated with the advertising for example subsequent clicks on ads, visits to other web sites with the advertiser's link on them, visits to the advertiser's web pages, returns to the cached pages, etc.

In a preferred embodiment users that respond to advertisements from the searching means might be directed to a pay site where they pay for items, perhaps run by, be an agent of have an agreement with, etc the search engine. For example a user might click on an advertisement in a location negotiated so that the advertiser pays a fee. The user might act in ways including for example clicking on at least one ad on the search results page, clicking on an ad on a web site the user found from the search engine results, the user seeing an advertisement on either of these or elsewhere and then searching the advertiser's web site and going there to make a purchase, etc. Any behaviour by the user verifiable by the searching means and/or advertisers with a predetermined level of certainty can be included.

Preferably the payment means can be a third part site that need not be owned or controlled by the advertiser and/or searching means but can agreements to report details of sales to them. The user's purchases of products or services can be assessed as to how much the advertiser should pay the searching means.

Preferably the searching means might host this paying means, monitor it, receive statistics from it, contact it periodically, etc and the advertisers agree to pay the searching means a negotiated amount of sales made through it. Preferably this is according to sales which can be linked as having occurred through the advertising and other efforts of the searching means.

The profits of sales might be split between the search engine and the web site owner, the advertiser, etc in a negotiated ratio. For example there might be an independent site which handles purchases of some items, though it could also be run by the owner of the original page and/or the search engine, or anyone else, even the advertisers. As long as a user purchasing there could be shown to an agreed upon level of accuracy that the sale happened because of efforts and displays of advertising by the searching means they would be entitled to a payment.

When people bought through that payment means the search engine would know how successful the search page advertising may have been and be able for example to charge advertisers based on a percentage or other agreed upon amount of the purchase price. For example the search page results might show ads that connected to a web site related to the advertisers. The user might click on an ad or link and make a purchase, and the search engine might take a cut of the purchase price.

In a preferred embodiment the user might go to at least one of the pages ranked on the search results, and make a purchase there. The purchase might be recorded as coming within a predetermined time period after the visit to the search engine and the searching means might get a negotiated cut of the purchase price. This includes the advantage that for example sales might be charged a commission on, but if the search engine ads result in no sales the advertisers might pay less or no charge.

If the cached site with the searching means has a link clicked to go to a payment means including for example a storefront, systems to buy or sell products, checkout, etc the search engine may keep records of this and see if the people bought something, claiming a fee including for example a commission, flat fee, a percentage, etc.

The searching means may also adjust the links in its cache to be directed to other cached pages. For example if a user on a cached page clicks on a web page linked there a cached web page might open. This would enable the searching means to more easily monitor the user's browsing habits, see the chain of events leading to a sale, see a user click on an ad and eventually get to the advertiser's web page, see the user click on the payment means site, etc.

In a preferred embodiment search engines may look at the history of web sites and other data sources, and how they change over time. For example if a web site changes in its site rankings with others this might be weighted as changing due to fashion or other factors. The changes might be analysed by all known statistical methodology including for example due to weather changes, seasonal effects, changes in the economy, sales of products, changing interest rates, any kind of stock market prediction algorithm, new innovations, changes in the stock market, etc.

Site rankings can preferably be analysed according to forecasting, charting like methods, etc to try to predict their changes, preferably for example to accurately forecast their usefulness as links to return in searches.

Preferably changes in how sites link to each other can also be monitored. For example a site might be linked to more often on a seasonal basis, or the changes might occur for other reasons. For example the site might be irregular in its maintenance and people give up on it, and then when it comes good again they link to it more. This can also be reflected in how site rankings are selected, monitoring the changes over time. The changes can be graphed for example by traffic to a site and the rankings on a search engine. For example the traffic results on a site might increase but the rankings don't increase, perhaps because people are going there more but not linking much more to it. These changes can be monitored and rankings adjusted to compensate for them.

In a preferred embodiment sites that are increasing in popularity, decreasing, wavering, etc can be analysed according to whether such changes follow a pattern including for example accelerating, plummeting, showing chaotic changes, random changes, etc so future positions might be predicted. Future positions and data about sites can even be gambled on, invested in like share prices, etc.

Changes can be used also to assess advertising rates, how positions in a site can be charged more for in times when they are popular, surging in popularity, etc.

The invention relates generally to classifications and more particularly to software.

In a preferred embodiment users make lists of their preferences including for example of music, movies, songs, books, magazines, web sites, games, colors, fashions, perfume, etc.

Preferably these can be published with a software means including for example on the Internet. Preferably said preferences can be examined including for example with a spreadsheet, database, sorting means, etc so people who have similar preferences can be assigned to various groups.

For example those with a certain level of similarity to each other's preferences might be in a first group. Those with a preferably defined level of still similar but not as closely similar as the first group would be placed in a second group, and so on with a user being in at least one group according to how similar his preferences are to other people's.

In another example groups can also be ordered with any other criteria including for example in set theory, group theory, etc. For example group A of people might have similar preferences, group B might have similar preferences somewhat different to Group A. There might be an overlap where people in Group A might share some of the preferences of Group B. So this can be represented including for example like a Venn diagram where Group A and Group B intersect. Preferably each group can be so configured, designed, ordered, represented, structured, etc so as to show their members, overlaps, in at least one category.

In a preferred embodiment people might have a plurality of lists of their preferences according to different categories. For example a first category might be foods, a second group might be cars, a third, traveling, and so on. All can be represented as groups and their intersections.

Preferably those in a first group can have permissions to interact with each other in a first way including for example forums, contact details, private information, group activities, etc. Preferably those in an overlap with a second group might be able to participate in that group's activities in a second way.

In a preferred embodiment a computing means including for example a program analyses at least one first data source including for example web sites, book, magazine, essay, newspaper, audio recording, song, lyrics, poem, TV, radio, image, documents, movies, animations, graphics, art, etc and provides a changing means including for example approximations, guesses, interpretations, translations, etc of the said data source including for example a semantic interpretation of it. For example the computing means might examine the said data source e.g. web page and have an interpreting means where its content is to be understandable, encodable, classifiable, indexable, ctaloguable, searchable, etc more efficiently including for example by standardizing the words in it.

For example a first data set including for example word, phrase, sentence, quote, etc might be examined and its location in a thesaurus or similar data is found, determined, etc. In some cases that word, phrase, etc might be found in a plurality of the said locations giving some ambiguity to its meaning.

Preferably if the said location is unambiguous at least one first word, phrase, etc that is a synonym, means approximately the same, etc as it is selected, which would be the second data set that corresponds, is associated with, means approximately the same as, etc the first data set. Preferably in the said changing means that first data set e.g. word, etc is replaced by the second data set.

Preferably then this process is undergone to create a second data source, in which the various data sets in the first data source e.g. a web page have been interacted with the said changing and interpretive means, including for example here where the semantic reinterpretation replaces the first data sets with the second data sets.

In another example the interpretive means might include a translation means where a first said data source is translating including for example from a first language or dialect into a second language or dialect, for example English into Chinese, etc.

Typically such a process would have inaccuracies which only humans could easily comprehend. Preferably then at least one section of each data source including for example a page, a bar (e.g. of a song), an article (e.g. in a newspaper or magazine), an act (e.g. in a play), a chapter (e.g. in a book), etc can have an associated third data source including for example a blog, Wiki, forum, metalink, mailing list, social interaction means, meeting place, etc.

For example a first data source e.g. a web page might use the said changing means, interpretive means, translation means, etc and have a result of a second data source which as said is likely to have various mistakes including for example mistranslation, using the wrong synonym, failing to recognize a quote or expression and translating it wrongly, etc.

Preferably the said associated third data structure might include for example at least one person who might use an interaction means including for example visit, log in, post, comment, lurk (e.g. read but not comment), discuss, argue, etc in an e.g. forum, blog, Wiki, etc and thereby create, edit, modify, etc a fourth data structure which preferably includes for examples corrections of mistakes, fixing translations, correcting spelling and grammatical errors, correcting semantic errors e.g. picking the wrong synonym, pointing out quotes e.g. including, putting, adding, etc a marking means e.g. punctuation marks, proofreading comments and marks used in the art, etc so the fourth data structure then preferably is better, more accurate in its required objective etc (including for example a better translation, a more accurate semantic representation, spelling is better, etc) for example of the objective of modifying the first data source for a preferred purpose.

Preferably the said translation means, interpretive means, changing means, etc can include for example examining the data of the said third and fourth data structures to determine including for example mistakes to avoid, comments in the third or fourth data structures might include advice to these means e.g. in a structured code or language, etc.

For example if the said means (translation, interpretive, changing, etc) encounter a first data set they might look for that data set in the third and fourth data sources, and see if there are any references. They might for example look in the second data sources their programs, etc might have created, look for the same or similar data sets to the first data set they are to act on, see if these have been altered, modified, deleted, commented upon, argued over, etc by at least one user in the third and fourth data sources etc.

Preferably then as the said means act on these corrections by humans they become more accurate and the said humans might need to modify their actions, processes, systems and methods, translations, synonym selections, etc less often.

Preferably a first user, computer program, etc might search contents e.g. of the said first, second, third and fourth data sources and compare the said results, including for example using the interaction means, making changes, comments, etc of desired. For example a first user might have a first data source e.g. page of a book, web page, etc and look for a translation. They might search for references, etc in a search engine and in the results might be the said second, third, fourth etc data sources associated with it. Then they might for example use this to interpret the first data source as required.

In another example a search engine might search for semantic data and the said search results might include the said second, third, fourth, etc data sources which might be used, interpreted, classified, catalogued, indexed, etc as required.

In a preferred embodiment advertisements can be associated including for example with the second, third, fourth, etc data sources according to a criteria including for example key words bid on e.g. like Adsense, an advertiser bidding on or otherwise paying for an add associate with a preferred data set they select, etc. For example an advertiser might prefer to advertise in association with a particular data set including for example a particular page of chapter in a book e.g. a travel company associating with a reference in a book about an area they sell holidays to, a particular song associated with a jingle or TV ad using that song or other references that might suit their products, a movie clip might be e.g. semantically or otherwise interpreted (including for example where the said interpretive, changing, translation, etc means might determine data e.g. the actors names, the location of the movie, convert their speech to text or a screenplay, determine the 3d data e.g. convert the movie from 2d to 3d by determining the 3d shapes in it by a system and method, etc) and advertising might be associated with preferred parts of the movie (including for example inserted into the movie like advertisements, adding content into the movie [including e.g. like altering the exampled film such as adding billboards with product names, adding objects recognizably associated with the advertiser e.g. their logo, changing a dialogue of e.g. an actor or narrator to mention, talk about, etc the advertiser's products, etc], etc), be provided at the start or end, etc.

Preferably then the advertiser could add the said advertising and it could be assisted in this by at least one person, program, etc using the said interactive means in creating, modifying, etc the said third and fourth data structures. For example users might in a social means e.g. Wiki write, modify, etc advertisements in the said data sources e.g. in a movie, book, translation, etc.

In a preferred embodiment advertisers might bid on, pay for, etc ads using a system and method including for example on key words in the first, second, third, fourth, etc data structures. For example a first advertiser might bid on a first data set and a second advertiser might bid on the same data set, and whoever pays the most might have their ad associated with that data set.

Preferably this advertisement might be used, displayed, etc in the first, second, third, fourth, etc data sources. For example a first advertiser might bid on a first data set e.g. key words in the first data source e.g. the original page of a book, a first section of a movie, etc. Their advertisement then might be displayed, provided, etc in the second, third and fourth data sources where it might be associated with a different data set, key words, etc. For example a first advertiser might bid on a first data set e.g. key words “NASCAR racing” in a first data source which might be displayed online e.g. from a page of a book, article in a magazine, etc. Then it might be translated into a second data source and that advertisement still might be associated with those key words, that first data set might now appear as a second data set where the words are retranslated, perhaps incorrectly into a second language e.g. English to Japanese. Then a third data set might be where people, programs, etc try to repair the incorrect translation but the advertisement might still be provided and in the fourth data set in the fourth data source the advertisement might be associated with the correct translation.

In another example an advertiser might select a particular aspect including for example scene, section, act, shape, person, car, animal, location, etc in a data source including for example movie, image, audio clip, etc and desire to associate his advertising with it, perhaps bidding on it against other advertisers. When a similar aspect is determined in another data source e.g. another movie, image, song, etc then their ad might appear with it in a preferred position, be heard e.g. as an audio recording with a song, be seen e.g. added into a movie or like a TV advertisement, hyperlink, etc, be viewed e.g. as a watermark, attached image, link, metadata, etc to an image, and so on.

In a preferred embodiment the said users, programs, etc might interact with the said advertisements including for example design them, modify them, improve them, change their position, change their size, change when they are seen heard or otherwise provided, etc. For example the said users might work to improve the advertising return for a first advertiser and receive compensation for it including for example payment, a commission on the payment the advertisement makes, a percentage of the payment per click the advertiser does, etc. Preferably people, programs, etc might specialize in these advertising task and make money from them, as they become more expert.

One problem with internet advertising for example is that using an algorithm e.g. Adsense is somewhat mechanical and can make mistakes a person would avoid, including for example inappropriate associations of key words. People then might as they make different versions of th said data sources e.g. the second, third, fourth, data sources for any purpose can also fix, improve, etc said advertising associations.

In another example a data source e.g. web page might include advertising with improved characteristics, data provided by an advertiser, etc. For example a data source on a first subject e.g. travel in England might have data provided by an advertiser including for example images, movies, links, coupons, discounts, travel tips, etc including for example associated with the said advertiser's ads. The people, users, etc then might contact an advertiser for this information, get it from other sources, display it in e.g. the third data source as additional or modified data sets, etc and so enhance, improve, etc the advertisers response from advertising.

In a preferred embodiment the said people e.g. those persons, computers, programs, organizations, etc using the said interaction means, working, etc on the said first, second, third, fourth, (and has many other versions as required) data sources might have an organizational means to allocate, decide, delegate, manage, etc various tasks including for example said modifying, changing, deleting, etc of data sets, advertising, etc. For example 1000 people might vote, offer modifications, suggestions, comments, selections, changes, etc any of the said data in the invention and voting on said e.g. changes might be done. This might prevent for example spammers, poor workmanship, etc. Also preferably any change can be provided, displayed, etc as an additional branch in a tree structure so people can see the older and the newer version and decide which might be better e.g. by voting. For example a second data set in a second data source is modified by a first person and appears in a third data source. Then a second person modifies it again, perhaps altering the translation for example or changing parameters of an advertisement. This change is provided in a second branch so now there would be two branches, one of the first person's work and another of the second person's work. Then a third person might alter the first person's work and a third branch is provided off the said first branch.

Preferably people can then see the different branches, discuss them, change them adding new branches to the process, vote on them, etc. At some point a third data source might be provisionally at least finalized as a fourth data source, e.g. like a finished product though it might be revised according to a system and method e.g. after a time period, after voting by people that visit or read it, after a certain number of visitors, after the third data source gets sufficiently different from it, such difference evaluated by a system and method. For example if there are X % additional branches in the third data source then the fourth data source might be revised. In another example if voters decide that Y % of the data sets in the fourth data source should be changed then it might be revised.

In a preferred embodiment a first set of search terms are displayed in a search result including for example with a second set of key words that might be use din a second search.

Preferably the first set and second set are key words usually inputted by a search query. For example a user might input a first set of key words for making a search, and a second user input the second set. Typically each search result is arrived at according to an algorithm, e.g. like Pagerank.

Preferably a first list of search results is provided according to the first user's first set of key words. Also there may be provided to a searcher other lists of results according to how a data source including for example web site, file, document, code, image, video, movie clip, animation e.g. flash, any result from searching a database e.g. of personal detail or inventory, etc. For the purposes of illustrating the invention but not to limit it, the Internet and search engines can be used.

Preferably a said data source including for example a web site can be analysed for different data it might contain useful for a search engine e.g. certain words which a searcher might input as a search query.

Often however a web page for example might be returned in different search results according to different search criteria e.g. different key words. For example a first set of key words and a different third set of key words might both return the same web page as a search result.

For example the search words “NASCAR racing” might return a first site as say the first result in a list of search results, and a third set “car racing driver” might return the same page e.g. as the first result.

Preferably then when a first search result is shown to a searcher from a first set of key words then results of where that page might appear in other searches from different e.g. key words (of course other search criteria than key words are contemplated in the use of the invention. For example a search engine might search images, movies, numbers e.g. on spreadsheets, any data known in the art can be searched, etc) can also be displayed.

For example a first user might input the said “NASCAR racing” and a first list of search results is provided, with a first web site e.g. nascar.com as the first result. Also provided to the user can be a list of other sets of key words on which the said first result scores highly. For example the words “car racing driver” might appear also indicating they are a second set of key words that would return this page (nascar.com) as the first result in its corresponding second list of search results. Then a third set of key words “tourism race track” might return the first web site (nascar.com) as its say third most highly rated search result.

So preferably a user can look at the other sets of search words and determine from their comparative ranking how the say first result nascar.com rates according to those different key words. He might for example be really interested in tourism and might see the third set “tourism race track”, click on a link associated with that set, and then go to a third list of search results more relevant to his query.

In another example the user might see a site is highly rated around sets of key words using terms like buy, bargain, sale, etc and conclude it is a commercial site, and he might in turn go to that site or avoid it.

Preferably the said key words can be associated with advertising including for example where advertisers pay, bid to advertise, pay per click, pay if a user follows a link, etc. For example a searcher might receive a first list of results according to a first set of key words. Advertisers might have bid, etc on this set of key words, bid on synonyms to these key words and their ads appear with said synonyms in search results, etc.

For example a first set of search terms might mean something similar to a second set of key words so an advertiser might bid, pay, etc for said sets of key words that are associated with each other in a defined way.

In another example the first search result is displayed, along with how preferably each link, result, hit, etc in the list of results would rate with other key words.

So a user can look through the list and see a number of other key word sets preferably for each e.g. web site listed, and so determines from these which link is most suitable for him.

So for example if a user clicked on a second set of keywords say associated with a first link in the first list of results then this might take him to a second list of search results compiled, determined, etc according to that second set of key words, and might also take into account that the first set of results was likely unsatisfactory to him so duplicated results might preferably not be shown.

For example the other result according to different key words though not yet displayed to the user might have duplicates removed in anticipation that if he rejects the first search results he likely doesn't want to see those links in e.g. the second search results.

Preferably as the results are shown for a second set of key words advertisers might have their ads shown according for example to how they paid, bid on that second set of key words, also e.g. the advertisers that bid on the first set of key words might also bid on their ads showing on subsequent sets of key words that the user explores. For example the advertisers might decide the user is searching and might if he sees their ad again on a second search result be more likely to click on it as it might seem to be becoming more and more relevant to the user.

In another example an advertiser might pay, bid, etc on advertising to be displayed according to actual results as well as or instead of key words. For example an advertiser might like a first site and like his ad to appear when that site appeared in a search result, and might for example pay more, bid more, etc when that site appeared higher in a search result, and might desire that site also appeared in a second search result (including for example if according to the system and method of the search engine that site might appear in other lists said duplicates might not be removed if advertisers want them to remain, etc), etc.

In another example a user might search for a kind of image including for example characteristics of it such as colors, resolution subject, shapes in it, etc and there could be provided in the search result what other criteria also might return the said results. For example a user might search for an image containing a face, scenery, etc and along with a first result might be displayed that a first image might also be returned as e.g. a third highest ranking result with a second set of search criteria including for example at the beach, blue sky, high resolution, etc.

In a preferred embodiment a user might have a selection means including for example ticking boxes to exclude or include aspects of a search including for example encyclopedia, dictionary, commercial site, shop, blog, forum, etc and the search engine might then return results more in harmony with that expressed selection.

Preferably the said results might also include how the said results performed with other criteria. For example if a user didn't select any criteria then a first search list might have the first e.g. top of the list result which had associated with it its comparative ranking using other sets of keywords as before. It might also say for example that a first search result scored highly when say commercial site or shop was ticked by other searchers. The second search result might also show that it scored lowly when other users clicked information or encyclopedia so a first user might infer the second result was not useful for information.

In a preferred embodiment the invention also can be used with other systems and methods including for example a proxy in search. For example a first list of search result preferably each has an associated link to the site, but this link can be directed, transferred, point at, etc at proxy including for example a server, the search engine or one of its software means, etc. For example a first result might be nascar.com but the link associated with that result might be approximately like http://www.search-engine-example.com/www.nascar.com, etc. So for example the search engine might receive this enquiry when a user clicked on this link, and would preferably then pass on the request to nascar.com which sends the user the requested web page. Usually the user doesn't experience a delay but the search engine can then determine which links are the most popular and which ones the searchers tried.

Preferably it can then determine from the various sets of key words which links are the most popular for each and adjust their rankings accordingly. A search system and method then can improve the rankings of various links, sites, etc as they are found to be more popular with searchers since it can determine from the last link they tried that the last link was likely the one they decided on.

Search has settings for filter e.g. no commercial sites, no warez, no unsafe sites for xp, no forums, no home pages, etc. Can check this first and untick shows then those sites unticked by themselves.

A preferred embodiment relates generally to networks and more particularly to advertising.

Search often has difficulty in finding useful results for users.

In a preferred embodiment advertisements can be used as a means to improve search results and finding data objects more effectively on the Internet.

To illustrate, advertisers typically avoid their ads being associated with poor quality web sites. Often more expensive ads, flash, movies, and the like might receive good traffic from some sites and poor traffic from other sites, especially such as spam sites and blogs.

So determining which ads are on various sites and how popular they are including how often they are clicked on, how often they lead to a sale and the like is a preferred means to evaluate sites. To illustrate, a search engine includes in its searching of sites, such as with web crawlers, monitoring what ads are on various sites. It can also include data on which of these ads are successful and to what degree, how much the advertisers pay to place such ads, and the advertisers might also have data including how often the ad is downloaded to a particular site when a user clicks on it, how much they pay such as the web administrator to host the ad, how many sales or other revenue they get off a particular ad, and the like.

To further illustrate, such data from advertisers can be used to monitor user movements in sites and thereby determine a site's popularity and relevance for search with particular key words. So a first advertiser might prefer sites that have content that relate to their products. Such an advertiser then if they advertise on a site indicates the site is relevant for key words associated with that advertisement.

Advertisers then can be included in a system and method to rank data objects such as web sites. To further illustrate the embodiment a web site might use an advertising service including such as adsense. Typically these rely on key words in a web site and the like to determine suitable ads to be displayed. One problem however is that spam blogs might be set up with little relevant content for users and still draw revenue from ads. So such users of a site might be less likely to buy something if they are annoyed by having gone to a bad site.

So various sites might have ads displayed according to a system and method that determines how useful the site is for the advertisers. To further illustrate an advertiser might typically sign up for a service such as adsense, but with the embodiment the advertiser might determine what sites his ad goes on, including a scale of fees for different site classifications. Further such advertising might include in kinds of data objects such as songs, music, video, flash and the like.

So an advertiser might also have an arrangement such as pay per click but where additional events might happen in association with a data object. To illustrate a visitor to a site might have to play a song, watch a movie post a comment in a forum and the like before a click on an advertisement counts as the advertising having to pay for the click. Also such a click that occurs without additional actions by a user such as the aforementioned playing a song or posting, might cost a user less. Further, if a visitor is longer on a site it is more likely the click on an ad is genuine. So in a previous application I referred to a means to determine how long a user has been on a site. This includes a file such as a graphic image which is slowly downloaded to the user's computer as part of the various files on the site, preferably a file not needed by the user, transparent, and the like. So to illustrate a larger transparent GIF might be downloaded to a user's computer slowly and the download is typically interrupted when they leave. So as long as the file is downloading the user is likely still looking at the page. So if a user has been on a page longer, say 5 minutes then it is likely the page is interesting, and also that a click on an ad after this time is more likely to be genuine than one that occurs very soon after the page is open. So an ad that is clicked after a longer time might according to a system and method be charged for more.

So to illustrate an advertising service might include the said downloading file which can time how long the user stays on the site. So then advertisers can the find out how popular the web page is, as opposed to one the user looks at for a short time and leaves.

So a search engine can use this data to improve its site rankings. A site where the users stay longer might have a higher ranking in results, and one that is consistently left after a short time might be lowered in ranking. So such files might be included with advertising if desired, and the benefit to the advertiser is more quality web pages carry their ads.

So to further illustrate, a user might search for data objects including sites with key words, that also include sites with a higher rating in relation to advertising. So such a system and method might give better results than others known in the art.

A search engine might improve the quality of advertising placement by examining sites with advertising and comparing the advertising aspects with key words and other aspects on or in the data object such as a web page. If an advertisement appears to be poorly placed then it might communicate with the advertiser or an agent suggesting the ad be removed, relocated, the advertiser check the placement and the like.

So the system and method can include a means to alert the advertisers to ways to improve their data object ads. Not all advertisers might take the trouble to assess such feedback, but it offers a service which can be lucrative for them.

So a first system might determine where to place ads according to such as key words, and a second system determine where they should be removed from.

To further illustrate, sites that have warez or pornography might be monitored for their ads and communication with the advertisers might remove these ads if they want. In a further illustration, ads might also be hosted, stored and the like by a search engine's cache, and an advertiser might pay for such storage of their material and content and perhaps pay less for hosting such data themselves. This also helps the search engine because it can determine how often the ads are downloaded, how the slow downloading files work to determine when a user leaves a site, and the like.

In a further illustration a site might have three ads. A first ad does well in sales, a second ad does less well and a third ad does poorly. So the embodiment would include a means to communicate with the third advertiser that their ad was perhaps less appropriate for the site and to include options such as relocating or redesigning it.

So this can include a system and method for determining the effectiveness of ads. So if the third ad works well on many sites but poorly on a first site, then it is likely to site does not bring people interested in the third ad even of the key words might indicate otherwise. So determining overall effectiveness of ads can determine their quality for their function and then individual poor responses on sites can determine either site is a poor site or the visitors there are not good for that ad.

So then the site can be assessed for its aspects. If the site does well with the first ad then it is likely it is a good site, and the third ad is less effective there. Also it can be monitored complaints of click fraud in such a system and method to determine if the first ads success is genuine.

So the embodiment includes a means to determine the third ad is misplaced and to try a fourth ad, including trying ads more similar to the successful ads without preferably selling competing products if the first advertiser complains.

Then the third advertiser's ads might be moved to other sites to try to their success. So such a system and method can determine effective ad placement even without using key words, and modify placement of ads when using key words as part of the system and method used.

In a further illustration ads might change in effectiveness through other factors such as seasonal changes, current events, weather, changed content on a data object or site, and the like. So these aspects included in a system and method might retry ads on a site they were less successful on, to determine whether it was a temporary lack of success. Such might also include changes in content on a site or data object to include in the determination of retrying advertising there.

So preferably a site or data object administrator, creator, editor, manager and the like might receive notification and feedback of ad results. To illustrate a first site might receive notice a third ad does poorly on their site but well elsewhere. They might receive a list of sites that do better with the third ad which might include suggestions of how to improve the data object or site to improve the performance of the third ad and thereby improve their own revenue.

To further illustrate, the search engine might also have content including that which changes dynamically which is useful for various advertisers. So a first advertiser might find their ads do better when current events are shown in relation to key words associated with their ads. To illustrate, an advertiser of NASCAR racing associated products such as souvenirs might find a means on the site display news about NASCAR and car racing improves sales. So such dynamic content might be associated with said advertising performance.

Further such content might be varies according to a system and method to improve such performance. So various topics might be included in such content, more than just related to key words and the performance of said ads is monitored. So such content might work better for ads by keeping people there longer rather than just being about NASCAR and the like. SO the content can be varies according to a system and method, monitoring the ad results, and preferably the content which is improving advertising results is retained and variations of that are provided so as to find more content that improves advertising even more. So to illustrate, content on racing might give a first set of advertising results, then including current events give an improved second set of results with a ration of racing news and current events. So this ratio of news to racing might be varied and its effect on advertising and other aspects such as the slow downloading file determining when the user leaves, how much users might comment in such as a forum, how many hits the site receives, how many files it downloads, and the like.

So said variations might include such data and by varying it might determine say 1/4 of the content on racing generates the best advertising results. Then it might still vary this ratio in future but perhaps less to try and determine any changes in this effectiveness. Then it might include weather results in various areas, and by the change in said aspects of user actions such as the slow downloading file and ad clicks it can determine what interest there is in weather, and what areas the users come from on the basis that they would be most interested in weather from their area.

So such content might be adjusted in its position, size, colors, fonts, flash animation, sounds, and the like in a data object such as a site according to the said user actions. Then it might determine an optimum amount of weather information and try other data including such as video or songs. So to illustrate such as youtube and the like videos might be hosted on such a site and the effect on advertising and other user actions monitored, also according to the key words and tags associated with such data objects of video, flash animations, music and the like.

Some data objects might be less effective as they might urge a visitor to leave the site and go to the source for their content and so advertising might suffer. So such variations might be monitored according to advertising effectiveness.

In a further illustration a first set of key words might be selected by a searcher and entered into a search engine. The system and method used to determine the ranking of the search results might include all of the aspects disclosed herein, particularly those sites in which the advertising is highly effective. So if a site has effective ads then it is likely that even if the site content is less appealing to the user they will be happy about having gone there because they bought something of value.

So such advertising aspects can appeal to a user including much as good ads on TV might improve a show being watched. Further, sites where users are known to stay for longer might also be weighted more highly in said rankings. Of course it is also important for the site to be relevant to the user query so key words on the site would also be important. Another advantage of the embodiment is the system and method would tend to exclude spam and other sites users exited quickly from, and such sites are unlikely to satisfy a search query. To illustrate it is unlikely a spam blog would assist in selling ads or make people stay as long as a legitimate site with perhaps the same ads.

To further illustrate, an advertiser might receive a communication including data on which key words their ads rank highly on. So this would include if a site ranked highly on a first set of key words then the advertiser might be notified of such a ranking since their ad is likely to be seen if the searcher selects this site. So advertiser might also opt for paying, bidding for particular data objects such as sites in a search result instead of or including bidding for ads to appear on a search results page. So to illustrate an advertiser might have an ad on a site ranked number 3 in the search results, and if the searcher clicked on this site he might pay for that click on the basis that the site was perhaps better organized to urge the searcher to click on his ad than the search results page might be.

Ads bid on and clicked in this way offer more ways to avoid such as click fraud. It takes longer for a page to load, and determining the cookies on the visitor's computer might determine if their movements in a tracking cookie and the like were associated with other click fraud.

In a further illustration ads on such as a search results page, and also on or in said data objects might also lead to sites, data objects, information for a searcher. So to illustrate an ad on search results might include useful information for a user, and include other ads which might urge a visitor to click on. So a searcher might click on such an ad, knowing it included information other than selling something, and an advertiser might pay for such a click. Then on the site the visitor might click on an ad on it, which might be recorded as a second click for purchasing something.

So to illustrate a visitor's first click on the search results page and a second click on the site might be accorded a weighting according to a system and method for payment. If say a first user clicked on the ad on the search results page and then a second click on an ad on the site this might be counted as one click for payment. If a user clicked on the ad on the search results page and no ads on the site then it might not be counted as a click for the purpose of payment or the advertiser might have to pay a smaller amount or ratio of the agreed upon click cost. Any ration and system and method of such click payments and fees is included in the embodiment, these illustrations are not intended to limit the scope but to clarify how the embodiment is practised.

In a further illustration such advertisements and the like on a site, data object, search results page and so on might also lead to a second data object or site including one where a second user has a web site. Such a site need not be affiliated or owned by the advertisers, but might be determined by a system and method to be effective for generating such as clicks and sales for the advertiser. So to illustrate, a second site set up by a second user has been effective for generating sales for a first advertiser, but might not rank highly for various reasons. The advertisers might determine sales and clicks occur for different reasons than the content in the second site might be ranked by a search engine. So to illustrate, a NASCAR racing advertisement might sell car tyres but finds it gets good sales from people interested in horse racing. So it might find it effective to bid on placing an ad for the key words such as horse racing, since the second web site might not rank highly for those key words. So an ad might include details of the site, and if searchers clicked on it they might still generate revenue for the NASCAR related ad. Preferably such an arrangement might include the said dynamic content including being provided by the search engines or other hosting related business for the said content.

So to illustrate a searcher might go to such an ad, and the second site might normally say nothing on NASCAR except for the ads. So then the dynamic content might determine the user came from such as the search results for NASCAR and add content on this subject to the site, whereas if the visitor came from a different referrer or search result then such NASCAR content might not be included.

So this system and method might be used by determining where the visitor comes from, and by determining this information, which is often included in data such as referring site in http request data, such content can be altered.

So to illustrate a searcher is monitored according to his key words and what links he selects. This can be done including by Java and Active X controls, also be cookies and my own embodiment of the hyperlink in a result pointing to a proxy or redirector of the search query, which then notes which link was selected.

So before a searcher clicks on such a result or advertisement the search engine and related systems can determine that the advertisement was clicked on by someone not really interested as much in horse racing as NASCAR and thus additional, preferably dynamically changing or provided content is included in the said second site. So the visitor to the second site sees content more on NASCAR, the ad on NASCAR, and so might be more satisfied. The advertiser might be more satisfied because he knows the second site is effective at generating sales. The search engine is happy because they receive payment for a click whereas they might not receive any money from a searcher selecting a search result. Also their links are improved because the paid ads as disclosed are more effectively targeted at people's needs.

So the embodiment includes systems and methods that improve rankings of effective sites, make sites dynamically changeable to suit searchers, and systematically try variations to improve site content for user satisfactions and ad revenue.

In a further illustration a first site is visited by a searcher, and then he goes to a second site. Typically in the http request is the name of the first site or other details about it. So the said dynamically generated and provided content can use this referral information to provide data to the said visitor in relation to data on the first site.

Such data might include many aspects. To illustrate, if the advertising service was the same, it is known the visitor might not have clicked on ads on that site, so there can be a means to include the same ads on the second site to attract attention, or to perhaps change them or have different ads on the basis the visitor might not be interested in those products. So further, the dynamic content might be associated with dynamic content or other data on the first site. So to illustrate a user goes to the first site and either clicks on a link on that site to the second site, or goes to the second site from such as a bookmark or other information, perhaps unknown.

In the case of clicking on a link, the data associated with such a link might be assumed to have attracted the user's attention, so such dynamic content might be provided on the second site in relation to that data associated with the like. Further, such a link might also point at a proxy or other means so the system knows the user is at a first site and wants to go to the second site. So to illustrate, the link might include in it the name of the first site, the address of the said proxy or search engine, the date the link was made (including where the link was created by the system including such as a search engine), and the like. Further, such a link can itself be dynamic. So a user might click on a link that is dynamically generated according to preferred criteria. To illustrate, the link might include a data object such as an active X control, Java, an image and the like, and this when downloaded might include a means to include a hyperlink in it. So such a data object might send information to such as the proxy that it has been clicked on or otherwise activated. So this might include such as when it was clicked on, what content associated with the hyperlink (including such as varying content around and with the hyperlink and so determining which content urges the user best to click on it, and is most likely to have urged the user to read it, listen to it, view it and the like), and such variations of this content can further urge user not only to stay on sites, click on advertisements, download materials, and the like but to urge them to move to a preferred data object including a second site. Then the second site having such information about the user might include said dynamic content also which might vary so as to improve it to such as keep the visitor at the site, click on the advertisements and so on.

So a second site might alter its content including the said dynamic aspects of it, alter advertisements and the like depending on where a visitor came from, where in tracking cookies he has been to, and the like. Further, the variations in such content and ads over time improve the aspects of the site to appeal more to users and to buy more often from the ads.

In a further illustration on tv ads complement the content of shows so ads can be seen as suitable for some shows and not others and their payments for such ads can control content. On web sites currently there is little or no feedback from advertisers on improving content in exchange for more advertising. One problem is that so many sites might have such ads that is has been difficult until now to provide such feedback. Since though so many of these ads are ineffective it is to the benefit of advertisers and site administrators to practise the embodiment.

A preferred embodiment relates generally to the Internet and more particularly to search.

Search on such as the internet has a major problem in that many results are highly unsuitable. Often they might be such as spam blogs and forums that contain little information.

In a preferred embodiment there is a means for lowering a rank of a search result. Preferably as substantial numbers are lowered the ones not so lowered thus rise, and the quality of search results increase.

To illustrate, many search results are next to useless but the rankings typically work by looking for positive attributes for a result rather than negative. So typically searchers are not looking for comments on forums and blogs, and the like. So preferably then such could be excluded or at least the user is given a screening option.

To further illustrate a searcher might be given options to screen out various kinds of searches rather than just options of what they are looking for.

So a searcher might have options to exclude such as commercial sites selling things, forums, blogs, encyclopedias, private web sites, and the like.

Preferably then the user enters various key words for what they are looking for and such filters or negative search criteria such as the said exclusions might be usable by a means. Such a means might enable the use to activate said filters and might include ticking a box or otherwise indicating a preference.

To further illustrate, a searcher might have a means to leave such filter settings on, and thus when they use search these kinds of results might be excluded by default.

So a searcher might exclude such as forums and commercial sites and such are identified by data on them. To illustrate then, a site with facilities for credit card payments might be excluded. In a further illustration sites with the word blog in a heading, using tables and frames typically used in forums, using comments in headings, having a plurality of smaller text written by people with different names or nicks, these might be used to determine forums and the like and thereby exclude them.

Further, a user might have such as spam filters for email which can filter search results. To illustrate, a Bayesian filter might filter out such as spam blogs, and a user might be able to select various results flagged or otherwise indicated by the filter as possible spam like or otherwise undesirable.

In a further illustration a searcher might be able to filter out such as warez sites, pornography and the like.

In a further illustration a user might be able to filter out sites known to have a smaller than a determined level of hits.

In a further illustration a user might be able to filter out sites with relatively unsophisticated formats including such as flash, frames, html errors and the like. Such errors and basic design might usually be associated with more amateurish or private sites and filtering in this way could remove them.

In a further illustration a search result might be filtered if it does not use a certain level of advertising on the basis that a site with little advertising organized is likely to be more amateurish and thus unlikely to have useful information.

In a further illustration sites that use pop ups might also be an option for filtering.

In a further illustration sites that are slower than a certain level to load including such as images, flash, text and the like might have an option for filtering. So a searcher might set this at X second to fully load on the basis that a slow server would be too annoying and the like.

In a further illustration a search result that is determined to not change for Y days might be an option for filtering. So a site that is updated is likely to be more looked after and have current information, and so more static sites might be excluded or filtered.

In a further illustration a search result with more than Z broken links me be a setting for a filter. So sites with broken links might be less well looked after and thus less useful.

In a further illustration sites containing capitalised words (such as LIKE THIS) might also be a filter setting. Such are often associated with shouting and might be further associated with undesirable reading.

In a further illustration sites using foreign languages or otherwise not on a preferred list of languages might also be excluded. All such exclusions and filtering and the like preferably have a means for a searcher to select them including the illustration of hitting a button, clicking a box, using a menu and the like.

In a further illustration there might be a first set of data objects including such as sounds, images, video, code and the like which might be a setting for filtering, and which might further be identified by their names, words or symbols in them in the case of code, or hashing them, and the like. To illustrate, certain images might be known to be offensive and so hashes of them might be compared with hashes of images on sites, and such sites might have such data objects filtered or even the whole site might be filtered.

A preferred embodiment relates generally to the internet and more particularly to search. Search has a problem in that the results for a search are quickly done by a search engine, often in a fraction of a second but then typically they don't change according to how the searcher reacts to them.

In a preferred embodiment a set of search results preferably appears in a configuration including such as a frame, a window, a table, a plurality of inserts, a plurality of sections, and the like. Preferably also data in the said configuration reconfigures including such as like a chat room, forum, instant messaging, animation such as flash, email client, and the like.

Preferably the results of the search are updated at least once more and preferably a plurality of times, particularly as the search results configuration is open, read, interacted with by the user. So to illustrate, the user is likely to interact with the search results and such interactions are data useful to search, not just for future searchers but to add, alter, edit, and the like the search results the user sees.

So to illustrate, the user might see a first set of search results including in a list. Then at intervals including a regular schedule, according to as new results are found, according to how the user moves his mouse, according to how the user clicks on various links, and the like new results might be included in the said configuration, the results might be reordered including so that results more likely to be required by the user might move up in the ranking, and the like.

So to illustrate a user might see the results change including such as every 30 seconds or so, and in such a process the list might change as new search results are found that are more relevant, other results might be lowered in the ranking, and the like.

In a further illustration, the searcher doing nothing while the results screen or configuration such as a web page is still open is likely to mean the user doesn't see a link he wants. So this can be a cue for the search engine to use more processing, search more extensively. Often the results a searcher wants may be on other pages deeper in the results, but instead of waiting to allow the searcher to get to say page 10 to find a result one might update page one or the like while the user observes, waits, reads so that something might come up better than what he has seen so far.

Such a system and method need not take large amounts of processing power. To illustrate, a means might be used in working out, determining the ranking of search results so that such might be reordered according to searcher desires.

To illustrate, a search engine might determine before a search various aspects of categories of search results typically knowing that the results shown are often diverse and the category the searcher is looking for may not be on the front page. Typically also though the search engine has a means to determine these category types including such as shops, forums, blogs, contact details, businesses, and the like.

So the embodiment includes a means so that the searcher can find these without having to necessarily search through often irrelevant results. To illustrate, there might be a system and method like a slide show where results might change in the said configuration according to a system and method, and the user might be able to alter parameters of such changes with such as computer controls.

To further illustrate the changes might be set to occur at a regular time interval or when the search engine finds new results. So a user might have a speed control so they change faster or slower, and if he misses a desired result he might reverse the process so he can see earlier shown orderings of results.

To further illustrate slide shows typically show sequences of data such as images, and also text such as in Powerpoint. So a search result might be provided as a presentation including such as powerpoint and similar programs, so a user might move through it and by such as clicking on icons or links, typing, voice recognition and the like indicate his desires in regard to such as the search results.

The embodiment also includes other uses than just for search results. To illustrate, a user might be looking for such as files in a computer or on a network and the looking might include such as the presentation. So a user might see various parts of computer storage being searched preferably with a feedback of the process such as seeing what files and directories the computer is currently searching. Preferably then the user might be able to direct such a search at least partially by various controls as disclosed including such as a mouse, voice recognition, keyboard keys and the like.

So to illustrate, a user might have a diagram, map, representation of various files, folders, directories, drives and the like on such as a computer or network. As such a search progresses he might remember more about where a file is and thus might be able to direct the computer to search a first directory at a higher priority than a second directory, even though at the start of the search the second directory might have had priority.

So to further illustrate, a user might further see the computer is searching irrelevant files such as video files and he might be looking for such as a document. So as the search progresses and preferably without stopping it, or at least while pausing it, he might be able to narrow the search including such as not searching irrelevant file types, files too large, files too old, and the like.

In a further illustration, a user might practice the embodiment while surfing the internet. So a system and method might determine a surfer's likely interest according to the bookmarks he uses, the links on web pages he tries, and the like. So on determining the user's likely interests such links, bookmarks and the like might be replaced added to, edited and the like with further means for the surfer to find other content.

To further illustrate a user might have a program including such as a frame, toolbar, pop up, and the like which can provide search results such as to a surfer. So as they go through various data objects including such as web pages, images, videos and the like what they are looking at might be searched in such as a search engine for related content.

So to illustrate a surfer might go to a first web site which might rank number 1 in search results on NASCAR racing, and so a system and method might determine it likely the user is interested in other results from that search, so such as the numbers 2 to 5 of that search result, i.e. the second through fifth search ranking using the key words NASCAR racing might be provided to the surfer.

In another illustration, a surfer might go through a plurality of web pages, following links and bookmarks and as disclosed various aspects are used to search for related content including such as if the user is searching images, search for documents or videos relating to the image keywords used.

In a further illustration a user might go to a plurality of web sites, to illustrate say 5 web sites, each with different scores in search. So a first site might happen to rank number 1 with NASCAR racing, even though the surfer might not have searched for this. Then the user might go to a second site which might rank say number 5 on “motorbike racing” if those words were entered into a search engine, the second site would thus come up number 5 in ranking there.

So the embodiment determines an interest in motorbike racing and NASCAR racing from these rankings. Then a user might go to a site which sells camping gear and happens to rank number 3 using the words “camping equipment”. Then a user might go to a site which ranks number 8 for key words “tools for bike repair”, and then the user might go to a fifth site which ranks number 2 for key words “weather Seattle area”. So the embodiment then has 5 sites which it can determine the user has an interest in, and preferably the embodiment includes a means to estimate, determine the likely connection between these.

To further illustrate it might weight the sites that are higher ranked as more interesting to the user. So a site that ranked number 1 for a first set of key words and a second site that ranked number 2 for a second set of keywords might be considered more relevant to the user's desires than one ranked number 8.

Further, the embodiment might list or otherwise analyse the search words related to the user's movements, here:

NASCAR racing (1), motorbike racing (5), camping equipment (3), tools for bike repair (8), weather Seattle area (2).

Preferably the system might determine further relationships between them on the basis that a surfer might prefer a site that relates to all of these or at least more than one of these topics. So the embodiment might search with all these keywords such as “NASCAR motorbike racing camping equipment tools bike repair weather Seattle” and so the ranking of sites found might be desirable to the surfer. So preferably the surfer might see such as the first 10 or so results like this.

The embodiment might further combine different numbers of these, such as sets of 4. So it might take the first 4 sites the surfer went to, combine their key words as disclosed and provide the surfer with a list relating to those key words. It might then take such as the second through fifth sites, combine their key words as disclosed and also provide them to the surfer, then sets of all three sites, sets of two sites and the like. It might even just provide the surfer with the top ranked result each time to save room.

So preferably the surfer's sites can be analysed, monitored, and the like according to the embodiment and relevant other search results determined and provided according to a system and method.

Such a system might include a sliding window of previous sites visited. To illustrate it might only do this for say the last 3 sites visited. To further illustrate it might do this for the last 10 visited, but discard out of this set 2 of them most unrelated to the other eight.

The illustrations then are not intended to limit the scope by such as numbers of sites monitored, the rankings of key words and the number of results provided to a user. Different numbers might be substituted here depending on what is most effective for the user.

In a further illustration a site a surfer or other user visits might rank highly according to a plurality of key words sets. So a first site might rank number 1 for “NASCAR racing” and number 4 for “driver helmets”, and number 7 for such as “Florida attractions”. So the additional key words sets might be included in the system and method such as to make the links and other data objects provided to such as the surfer more relevant. So to further illustrate,

NASCAR racing (1), motorbike racing (5), camping equipment (3), tools for bike repair (8), weather Seattle area (2), might have added to it: driver helmets (4), Florida attractions (7), and so now there would be more combinations of key words which could be searched and links provided to the user.

In a further illustration the embodiment might further include the ranking of the various sites, such as “motorbike racing (5)” to determine how the final list of results might be provided. So a combination of such as the first and second ranks “NASCAR racing weather Seattle” might have its highest ranked result or results provided first to the user. To illustrate, he might be deciding to watch NASCAR on TV and to visit someone in Seattle and watch it there. So this kind of motivation is hard to predict, but high ranking relevant sites can be useful to the surfer.

In a further embodiment then search and other computer related activities preferably can update, refresh, change, edit in real time and preferably at least quickly according to user desires and actions.

To further illustrate, a searcher might select a first link in a first set of search results, so it might be assume that this link had something in the provided data that looked relevant to the user. So then a list of related data objects including such as web pages to this might be provided, such as when the searcher went back to the results page, in a toolbar, frame, pop up, and the like.

As a user looked at a plurality of links the system and method disclosed might check those links for such as other key words in which they also rank highly to see if there is an alternate motivations for the user. So if a first search result on “NASCAR racing” had a ranking of number 3 for “driver racetrack” and a second link in the first search result had a ranking of number 4 for “Texas nightlife” then combining these according to a system and method might include a search for “driver racetrack Texas nightlife” and also for as disclosed any 3 of the 4 key words, and 2, and so on. So the first link for these 4 keywords might be a site which discusses nightlife in areas after races in the NASCAR circuit. Such a link then might be hard to determine otherwise.

One of the main problems in search is finding suitable results for a user, and also quickly enough so he is satisfied. If the results do not contain a suitable link high enough in the list returned to the user with a given set of key words the user might well go to another search engine.

The embodiment includes additional feedback from the searcher by assuming that if the user goes to a second page of search results then there is likely something wrong with the first page. A user might be looking for a particular kind of link and the first page of results might well not be suitable. Especially if the users actions are being monitored it might be assumed that his not trying any of the links on the first page, or at least going to the second page means none on the first page were suitable.

So to illustrate, knowing a user doesn't like a particular link is useful because the embodiment includes a means to determine aspects of it, and preferably show less of those aspects to the user. So a first link on “NASCAR racing” might not be selected by a user and it might rank highly as said with driver racetracks. So it might be assumed the searcher is less interested in that and so other results that score highly with the key words “driver racetrack” might be lowered in ranking including as disclosed when the web page or the like is refreshed, updated, and the like.

In a further illustration the searcher might not select the second link which scores highly with “Texas nightlife” and so other results that score highly with these key words might be lowered in ranking.

So by determining the user does not try these 2 links it is likely the user is not interested in drivers, racetracks, Texas and nightlife. Therefore other search results that are less about these subjects and key words and more about other aspects of NASCAR racing might be ranked more highly.

Further, the embodiment includes other means for determining user intent. To illustrate, a third link in the first search results might be a blog, and the fourth a forum. By his not selecting them they might score highly using key words of such as “blog NASCAR forum”, “blog NASCAR” and the like, and so it might be determined the user is not interested in forums. So thereby other results which score higher using blog or forum related key words might be further demoted in the ranking as disclosed.

However usually a searcher finds a useful link on the first page since these according to a system and method are the most likely links for the user. So instead of simply giving more links with the same system and method on a second page, or a given number of pages the invention provides for beyond a particular point that the links use a second system and method, or algorithm.

A user might be looking for an unusual interpretation of key words and if a search engine uses a system and method then it might return a list of results according to a first interpretation but not a second one. So after a certain number of links with a first interpretation of the searcher's key words, the next set of links might have a different interpretation. Having this change occur on a next page allows the search engine to know the user was dissatisfied with the first page and so the second page can exclude certain criteria it infers the user is not interested in. Also the search might further determine from the time spent on a particular page of results how relevant they are. So if a user quickly moves through pages it might be determined few are relevant and so further pages might be provided with different interpretations, different content and the like.

So to illustrate the search might prepare 3 different second pages of results. If the searcher takes a long time and tries several links on the first page then the first prepared page might be on similar results to the first page, or further might be updated as the user tries different links from the first page, so by the time he requests the second page it is redesigned with the new data from the user. The second page might be ready if the user quickly requests it on the basis the first page not be at all relevant, and so the second page might be more different such as more forums, more contact details, more shops. So the second page might be an attempt to more rapidly determine user intent as the speed of rejecting the first page might mean the user is likely to give up if not satisfied quickly.

A third version of such as page 2 might be ready in case the user spends a longer time on at least one link on the first page, and so it might be the user wants a result most like such as the fourth link on the first page. So the search engine might process the database of results it has to more carefully, more accurately determine the similarities between the fourth link on page 1 and another link.

To illustrate, an in depth search like this might determine that any other ranking the fourth link has with different key words might be relevant. So it might determine that the fourth link appears in the top 50 ranking with 20 other sets of key words. So then it might use these 20 sets of keywords and as disclosed determine highly ranked sites with these words, in combinations as disclosed, and preferably if possible a site highly ranked by searching all 20 sets in one search.

Of course such search methods are not intended to restrict the scope. Here it is unlikely 20 sets of key words might be combined and come up with any web page containing them all. The embodiment though includes the responding to subtle user feedback so as to downgrade and upgrade rankings of other sites, preferably in real time. So a user should find as he continues that instead of search results getting worse and worse, they should improve, and also that a pattern relating to various links might emerge that is more interesting than the original search.

So the embodiment includes a means for a user to surf search results, by his movements the results change and follow his desires and away from his dislikes so he should find the journey through the results more intuitive and related to his interests.

Such a system and method can also be used even on a single page. A user might see a first set, list, and the like of links, site previews and excerpts and the like and make some feedback including scrolling down, moving to another section of a page, clicking on parts of a frame to see more results. So this feedback can indicate to the search engine that different kinds of links are desired. Such movements can be monitored including by such as Java, cookies, Active X, Browser Helper Objects, and the like.

One advantage of the invention is the user's responses can be timed, on the assumption that if the user does not quickly select a link then the information is unsuitable including obscure, not relevant. So search results can also be displayed dynamically in that results can be changing on at least one page over time.

To further illustrate, a user might scroll to a link then scroll back up again away from it, indicating it was less suitable. He might examine a preview in such as a balloon window or popup and then not follow the link. So as disclosed these actions can be effectively used to change the rankings of other search results.

Such dynamic pages are known in the art and can include those with animations, movies, shockwave, flash, updating sections with changing data. Search results then can use methods and systems such as these to present a changing set of data.

To further illustrate, a user might read a first search result and including by feedback such as clicking on it, moving a cursor on or near it, looking at it, cause the information in the result to change. Some changes are known in the art such as a pop up of more details about the link. The invention contemplates these changes are dynamic in that they can show additional parts of the search result the longer a user looks at the result.

In a further illustration, a user might look at a preview in such as a pop up window or balloon, and by holding it longer than a time period then it might show additional previews such as more data from the link. Further the data shown and which the user requested more might be determined to be less interesting and so other links with similar data to that might have their ranking lowered and otherwise preferably move downward in the lists of results.

Also the assumption is that the other links in the result need be static, though this is not necessary and usually not desirable. A search engine usually devotes a particular amount of time and computation to a given search query, but it can also continue to work on this problem if it knows the user is not satisfied. Currently in the art the search results are provided to a user, usually in a plurality of pages, and the search engine devotes little or no further work for the user.

In contrast to this the invention provides for the search engine to work more on the user's request and preferably to update, push, change, and the like the results the user has received according to this continuing work.

So a user might receive a first set of results, but these results might be changing dynamically the longer the results are displayed to the user. He might be examining a first link and the second link might be changing according to which parts of the first link the user is examining. Also if the search engine has determined another link or list of results is likely to be more useful to a user it might send this immediately or at least after a certain time period rather than leave the user with outdated results the search engine no longer determines are the best.

So this is more easily done by a first page being presented to a user, and a second page being dynamic in that according to actions including behavior of the searcher, further computation, new changes to indexing, the second page of results might not be the same depending on how long before the user clicks on the next page's link, which links he looks at on the first page, whether he clicks on any advertisements on the first page, how long he looks at such ad's links, such variables determining according to a system and method what further results the searcher is provided with.

In a preferred embodiment then a user might be provided with a substantially dynamic list of results. At times a user might be intending to look at a link and then it changes to a different link. In this case he might using an indicating means including clicking on a link, hovering over a link or area, so the previous result is again shown to the user.

Other wise a user might examine the said dynamic results and instead of or in addition to looking through many pages of results the results on at least one page change, so when he sees a good search result appear he selects that.

Further, the user might interact with this dynamic data including using a mouse, cursor, keyboard, looking at an area (in the case where his eyes are monitored for what he is looking at). Such interactions might include responses such as changing search results in an area indicated by the user, holding a search result from changing for a set amount of time, expanding the preview seen from a particular link. Also the user might interact with controls associated with this process including toolbar, frame, links, icons, java applets (and similar code in its function), particular words and phrases.

A search result might then have such terms associated with it as “more like this”, “nothing like this”, “similar”, “try more unpopular links”. The user interacting with these can dynamically alter the search results, not only with those displayed and those displayed next according to the user's wishes, but also in those that are queued to be shown.

So a user requesting more unpopular links (on the basis including that he is after some unusual interpretation of the key words) might have a queue prepared by the search engine of such links, but which will be displayed over time, say sequentially but if the user then starts looking at some other aspect such as “nothing like this” then this queue might be altered to other characteristics rather than those links which are unpopular.

The invention then contemplates the dynamic, including the changing of results, the working on results while the user is known to be still searching, the bringing of more results to the user on a page instead of or in addition to him having to search through other pages.

Further, a search engine might work on the said user's query and later provide more results including by email, a messaging means, on a blog, a forum, a home page. So a user might check back on a link for the said results later and find these are updated. Preferably this searching would require some feedback from the user after a time limit, otherwise the search engine might continue to work on a request the user is no longer interested in.

So a user might make a search query with a first set of key words, and including the other aspects of the invention disclosed herein, might decide to look later at the changing results. So he might have a means to do this including having a particular link to this dynamic results such as on a web page for him, on a forum, on a blog where the search engine adds comments and suggestions, in emails received from the search engine with new results.

On examining these new results the search engine might have filtered out more irrelevant links and improved the ranking of results. This represents a more efficient use of a search engine's computational power since currently the amount of processing power devoted to a search related to the task of finding the results, and examining various algorithms. If a user is known to be dissatisfied a search engine can assume the key words have a problem including that the results are not very good, they are innately vague, the results include spam and deception (such as people gaming the search rankings, spam blogs), and so it can devote more processing power to fix problems it knows exists.

Also the user might give a feedback on the results without requiring more work on this, and if the assessment is poor the search engine might determine these key words need to be worked on more so next time the results are better for another user.

The characteristics of such dynamism can be according to a system and method based on various factors including feedback from a searcher (including clicking on, hovering a cursor over a speed up or slow down icon, link, image, text, representing the rate of change of search results and associated data), determining from user responses (including monitoring which links they click on or preview, which pages they visit, which ads they visit [by various means including using cookies, having links including the address of a proxy server, using Java and related code to send details of user actions to the search engine]), various times and positions determined to be effective for displaying ads to a searcher.

The format and content of said search results can also be dynamic. So characteristics such as fonts, font sizes, font colors, bold, italics, underlining, image sizes and positions, using flash for some search results, can all be used to present results so that they are effective including holding the user's interest, catching their eye, color coding some types of results (including of a particular type might be in a similar color or font), using icons to point to some links.

One advantage of using relatively plain text is that dynamic updates can be done more quickly. Using format including flash and shockwave can also contain search variations so that user input or direction from the search engine can change the content shown. So a user might be seeing a first result in flash and further results might be also in that flash data. On user input including the said actions such as hovering a mouse or other cursor over an icon, the flash or other dynamic media might change the order of shown results, request more data.

A preferred embodiment relates generally to software and more particularly to search.

Searching is an important part of using the Internet but it is time consuming for searchers to find what they want. Usually a searcher receives a huge list of results over many pages, and often either picks a top link because it is easier to get to, or has to laboriously look through many unsuitable links.

In a preferred embodiment a means is provided to enable a user to see a plurality of search results more easily. Preferably a search result can be listed in a way so more of them than typically shown on Google and the like can be seen on a page.

Such presentations, listings, and the like might include additional data objects including mash ups, movie, flash, sound, Ajax, Ruby on Rails and the like. It might also include links to blogs, forums, web sites and the like which include commentary, assistance, posts on a particular search result, set of keywords, and the like. So a searcher might be able to not only view a list of search results but view comments from other users on aspects of his search including key words, those search results, and the like.

Preferably it can be provided for at least one search result what other key words the result scores highly in. So a searcher might see a list of results, and instead of or including a preview of some text from the result (which often is not particularly useful for evaluating the result prior to selecting it) the user might see other information including at least one of the name of the site, the author of the site, social bookmarks related to the key words, SIP ratings such as used on Amazon where the key words are shown in relation to other statistically significant words (including where words normally not associated with the key words might lower the rating of the site or result on the basis that the result is not specialised on the key word topics), tags on sites images movies music or other data objects related to the key words, site rating including by people or an agent or company, what other keywords the site scores well in and preferably how highly it scores (on the basis that high scores in related keywords might be useful information to a searcher), rating from an associated blog, forum and the like, comment from said blog or forum (including a comment voted or otherwise rated highly enough on this forum by people or such as a blog moderator. This means the comment can be more useful, substantially like a critic's opinion than just a segment of text from a site which might often be spam), pagerank of the site, rating of how many other user's selected this site (including such as a plurality of other systems used to rate sites. So a search result might have a rating under pagerank, under how often key words were used in it, a personal rating by a reviewer, a rating based on monitoring how often people went there, number of hits or other traffic the site or page gets if known, content rating including based on profanity or violence, spam rating based on a Bayesian filter or other technology for determining if the site is spam, warez rating based on whether the site contains links to illegal software and the like, porn rating including links to porn and related advertising, advertising rating including what kind of ads there are (including ads targeted for that site which might be related to that content. So if there is an agreement between the key words of a search result and the association with advertising on that site then it might have a higher rating), how many other links there are on the site and what kind of content they link to (including where this content is rated according to how well it might rank on the searcher's key words or related words. So a web site with links to other sites that also rated highly on the searcher's key words might receive a higher rating on the basis that the web page is more likely to be about that subject. Another web page with links to sites that score lower might be not as authoritive on the searcher's key words),

Preferably the said results and other data disclosed herein could be arranged, provided, presented in substantially other than a typical numerical list. So the said ratings, details as disclosed might be shown in sections such as boxes, windows, tables, cells, frames, pop ups, as nodes in a net like pattern including with connecting lines between them, a grid, and the like.

Colors, textures, patterns might be used to show particular data of interest to a searcher. So higher ratings might be shown in a first color such as green, medium ratings such as yellow and bad ratings such as red. So a searcher might see a result with a plurality of green ratings, and fewer red ratings and decide to try that result. Further the ratings might be represented as symbols, icons, images, animations, and the like preferably in ways more easily understood by a searcher. So pagerank might be denoted by a first symbol, searcher monitoring of his selection by a second symbol, spam rating by a third symbol, and so on.

Preferably then more results could fit on a page because unnecessary previews and/or other data including the link name could be removed if desired. Usually it tells a searcher little to have the name of a site.

Further, site classifications can also be represented including by said symbols and colors, animations, and the like. So a blog might have a first representation, an encyclopedia a second representation, a private site a third representation, and so on. A searcher then could quickly see which kinds of sites and data objects such as songs, movies, documents, and the like a result was, rather than having to select from a menu what they want. So the results might include a format similar to a map with a legend, symbols, show connections between sites if they link to each other, and the like.

So a first result might be shown as a first node with other result linked to it with such as lines, and other graphical representations, so a searcher could see which site was popular amongst other search results.

Preferably also the results could continue to update. A searcher might see the results changing as various rankings change, comments on blogs and forums about search results change, as new sites related to key words are found or crawled, as new results are determine by the search engine (including on the basis that the longer the results stays open the more likely the searcher is unsatisified about what is shown. So if a searcher goes into a link and then back then this could be taken as a sign to update the search results, examine whether other search results are similar to the link rejected and perhaps remove or reorder them in the search results, and so on. A searcher might also save their results, bookmark them come back to them later, and the search engine or associated software might continue to work on it, improving the results, having people review the search for problems, have it mentioned in forums that people have been unhappy with searches on these keywords so people on a forum associated with these results or key words might make suggestions or comments, have sites listed in the results checked again for spam, have sites listed in the results contacted with commentary on how searchers find and think of their site and how to improve it, and so on.

In a preferred embodiment results can also be provided in a format similar to a reference work including an encyclopedia, dictionary, thesaurus, Wiki, Journal, book, and the like. So a searcher might see results for key words including as they are found in articles in such as an encyclopedia, and then the key words in such articles are further searched as probably associated with the searcher's key words. So said reference works can provide including a template, guide, structure to a search.

So to illustrate a searcher might use the words NASCAR racing. Then at least one result related substantially to a reference article as disclosed is provided and further that links, search results and the like are provided that related to terms, words, and so on in the said reference article. So a reference article might provide details such as driver names, racetrack names, history of races, and the like. Then preferably links could be displayed according to said key words and other criteria in the article. So links provided might include the said driver names, race tracks, history of events so the search includes much information relevant to NASCAR rather than often site results that only tangentially refer to NASCAR.

So preferably a site to be displayed in search results should rank substantially well in relation to these reference writings, articles, entries, papers, and the like. So preferably to be shown a NASCAR site should have information not only to NASCAR racing but also to other key words in the encyclopedia and similar article. So a site that referred to as disclosed by illustration NASCAR history, driver names, track names and the like might be rated higher as the site tends to be similar according to effective criteria with the data in the said article. On the other hand a site that had few relations with the reference article might not rate highly.

Typically a reference article might link to other related data, so NASCAR might often in a reference work link to such as formula racing, history of the racing car in general, physics of car racing, engine designs and the like. So often these details might be provided in links to other reference articles. Then preferably these other aspects might also be shown in search results according to criteria such as whether a site including a preferred mix of key words from a first reference article and a second linked to reference article, whether the keywords in the site (or other data objects can be substituted here for a site) referred mainly to another linked article and little to the illustration of NASCAR, whether a site ranked more highly to other research articles and so was unlikely to be specializing in NASCAR and so on.

Preferably the format of search results could include that similar to the said article. So an article could be shown and links to said data objects shown including according to ranking in a format including at the end of the article, at the beginning, interspersed through the article, linked to key words in the article, in a frame on the page with the article, in a pop up, shown when a mouse is held over an icon, and the like.

So a searcher on a subject could quickly see what the article was about, what related articles there were to it, and might then find the article that best reflected his query. Then sites and other data objects liked to an article were preferably most about the data in the article and so the said article can include a guiding principle to the organization of the data.

Sites selected can also be ranked by monitoring the user including which links he selects, and so when a user selects a link it might be interpreted as being more useful particularly if the searcher does not return and so might be rated more highly next time.

A preferred embodiment relates generally to networks and more particularly to search engines.

Searchers often have a vague idea of the information they are searching for, and usually a search engine has little means to help them to define this better. Sometimes they might have a list of classifications such as shopping, encyclopedias, and the like but searchers rarely use them.

In a preferred embodiment searchers and other computer software users are provided with a means to question them including to help them, narrow a search, set up software and the like.

So to illustrate with search engines a user might be looking for information on “NASCAR racing” and the search and related software might create, modify, provide and the like questions to the user. To further illustrate, software with a means to create such questions might be used, similar to such code and programming used in the Eliza program. This was designed to take data from a person's typing, responses and the like, and create questions using some of the same words. A user then got an impression of a program asking leading questions that appeared to understand more of him than it really did.

So in a further illustrate with “NASCAR racing”, a search engine and the like might ask the user “What do you want to know about NASCAR?”, and might preferably give multiple choices answers which a user might respond by clicking on boxes, ticking in locations, and the like.

Often of course searchers and other users are not interested in answering questions from software. Those that do though would find the system and method could assist them. So to further illustrate the user might say or tick such as a box that he is interested in racing cars. So the search might respond “So you are interested in NASCAR racing, any other kind of racing as well?” and might further use data in search results to suggest other aspects. To illustrate, the search might have found that web sites that rank high with NASCAR racing also rank high on racetracks, racing car drivers, even Formula 1.

So the search might respond like “I have information on NASCAR racing, also some general data on racetrack and NASCAR, also more general on car racing, and Formula 1. Are any of these useful?”. So the search engine might receive such as a yes or no answer, a user might be able to click on words, symbols, links, and the like in the questions as a response and the like. So to illustrate the user might click on Formula 1 in the question to indicate his interest. He might in the case of clicking on “no” in such as a word in the question on a button, using a slider, using controls that respond to user input such as voice recognition, image recognition, active X, Java, Ajax, and the like.

The embodiment is particularly well suited to voice recognition. So to illustrate, a user might do a search or otherwise give directions and other controls or data to a computer. It can then create such questions and thereby reduce errors in such as voice recognition and determine more accurately user intent by narrowing down the possible desires of the user.

So to illustrate with search a user might say key words (of course this includes other means of interaction such as typing and the like), and the search asks questions which assists to change misperceptions on the computer's part such as incorrect word recognition, the wrong category related to key words, and the like.

So a searching means might ask the user to confirm the key words by saying them, displaying them on a screen, emitting them to speakers or headphones, showing interactions in a movie or other display animation and the like. The display allows more aspects of the embodiment since the user might be provided with an avatar, image, animation, character, and the like to interact with.

So to further illustrate, the embodiment might ask the user said question, narrowing down aspects in the illustration of NASCAR, comparing the responses to search results, and providing them, also giving the users various means of communicating answers.

The system and method can be like a menu where a user might press buttons on a phone, type in responses or data into a form such as online or in a word processor, add data into boxes in a spreadsheet, type words on a command line in software, do menu selections with voice recognition and other menus used in the art.

The embodiment however further includes the means for any of these to alter in response to user input, to create new menus, to alter existing ones, to receive from storage other menus and the like. One objective of the embodiment then is to determine user intent rather than just give predetermined menu and other selections that may not fir the user's needs.

So the embodiment goes far beyond the scope of typical software and hardware. Usually software is designed with options for a user, and these options are typically designed to apply to everyone so most options are not used by a particular person. However the need to provide so many options makes the typical interface complicated when often the user only wants to do things that a simpler interface would provide.

So to further illustrate a program might ask said questions and the user by his answers can allow any kind of interface to be set up, customized and the like. So to illustrate, a user might load a software program that provides less user options and the means to the said questions and answers. It might even have no initial options except a way to start the question and answer process. So to illustrate a person might start a computer and a voice might be hear, an image might be seen of such as an avatar, text might be seen and the like, asking questions including what they want to do. The embodiment then might be included in any kind of machinery including such as a car, a computer, a household appliance, a mower, a letterbox, a door, a lock, a window latch, a mobile phone, a pen, a set of glasses, a can to be opened, a printer, a modem, an authentication means such as to log on, and the like.

So to further illustrate a user might respond to a question about what they want to do. In an illustration with a mobile phone they might say they want to phone people, keep phone numbers, receive email and SMS, browse the internet and the like. So preferably the embodiment would ask the user based on these responses how to set it up, including such as what menu type they want, do they have email details, what numbers do they want to call or store, what web sites do they want to visit, what security measures do they want to use, and the like.

So the responses to such questions might in turn according to a system and method have the embodiment provide more questions and so the user customizes the devices as he requires. Further, the embodiment might provide examples of this setup, confirm operations, ask if the user is sure, and the like.

So such a customization can enable a user to learn as much as they need to. Also the said embodiment can assist a user to improve their interaction. So to illustrate those parts that result in confusion, misdirection and the like can be clarified through further questions and answers. So if a user is poorly understood through speech recognition the embodiment might negotiate, attempt, and the like a further means of communications such as switching to text, changing the words used to be less ambiguous and the like. So to illustrate, a user might have a location of data called “mail” and a second location called “mates” as friends. The embodiment if it misinterprets more than an amount might select a means to solve this including asking if such names, tags, systems and methods might be changed. So to illustrate mates might be suggested as being changed to friends.

So the embodiment includes a means for said questions and answers to use data such as from the user to frame, create, modify questions and the like so as to customize the various interactions. Preferably such a process might reach a point where questions might be rarer since the process the user followed has been worked out to be less ambiguous for the embodiment.

To further illustrate, a user might query search not just for web sites, music, movies, flash and other animations, documents, and the like, but also to find out information in such as an encyclopedia, make appointments, use a calendar, make meeting times and places, manage a budget, check schedules for such as buses and trains, and the like.

So to illustrate, a user might want to look up a train schedule, and the questions narrow the focus or scope of the query so that the embodiment determines the query is not about web sites, encyclopedias, calendars and the like, the times required are determined, which train line might be determined and the like.

So such a system and method might be more lengthy to use in some cases than simply selecting multiple choice but the embodiment is more useful in some situations. To illustrate, a user might be on a phone and the said questions and answers find the information better than using a small keypad. He might also be driving or walking and be able to talk and listen, and so work out the data he seeks. To illustrate, he might be walking along, have a mobile phone or computer, and by such questions and answers find out where a bus is leaving from, where he is and directions to a building or locations, ask for a message to be sent to someone by such as SMS or email, ask for a definition of a word, and the like.

Preferably also the embodiment has a means to store and recall previous responses by the user, and also preferably typical responses from other users. So a first question might have typical responses from a wider range of users, which might be determined statistically and the like to relate to various categories. So the embodiment might know initially how users respond typically, and so determine a likely course of questions to ask the user so as to quicken the time taken to narrow down what the user wants to do. Also previous responses of a user might also be included in data the system and method can use to create and modify more questions.

So to illustrate, a user might be asking about taxis and the system determines what taxis the user previously took. It might then ask based on this whether a particular taxi company is preferred, whether he wants to go to a same place he went to previously perhaps giving a list of locations, whether he wants to pay cash or charge it, if he wants an estimate of costs to a destination, if he wouldn't prefer a bus (including where the system determines the user also asks about buses and the like), and so on.

In a further illustration the embodiment might determine a system and method of doing a task from a first user, and then provide this data to a second user who might with further questions and answers respond including by approving part or all of it, change parts of it, ask for clarification from the first user and the like. So the embodiment can act including like a secretary or worker, clarifying systems and methods not only to a user but also between users.

So to further illustrate, in an office such a system might be used by a plurality of workers. Often they might use such as a Wiki or Sharepoint to collaborate on. To illustrate the embodiment might be used with typing and text though of course the other means such as voice recognition can also be used. So a first user sets up a data object including such as a web site, code, document, spreadsheet, database, edits an image or movie, makes a presentation such as like Powerpoint and the like. Then a second user might instead of or in addition to altering it as might happen with a Wiki responds in a further question and answer session, and might also be provided with answers the first user makes where they conflict. So to illustrate a web site might use a first image as background, a first font, a first heading, a frame, a Java snippet and the like, and a second user might want to change at least one of these. So the system and method might ask if the second user wants to change what the first user did, whether the first user might be consulted, who has the higher authorization, and the like.

The system and method of such as question generation can include statistical methods. So to illustrate a user might use a set of words in a sentence and these system might determine those words are most often used with a first intention, second most often with a second intention, and third most often with a third intention. So it might ask “do you mean the first intention?”. So to illustrate a user might say or type something that includes the words “look up John at home” and the system determine this most often means to phone John from work at home, second most often to search in a home database about John's details, and third most often to mean John is at the user's home and to call the user's home phone. So the embodiment might include the three or so most likely options in a sentence, ask about the first option, then the second, and so on according to a system and method, ask a leading question asking for clarification without offering options since the user might respond with further key words, and the like.

In a further illustration a user might have a means to interact with an image such as a movie, animation, video conferencing and the like. So he might see a character, persona, animation, avatar, and the like. The system might further determine actions based on further data including such as recognizing the user's face expressions, tone of voice, stress in his voice or face, emotions in his expression or voice, where he is from the background, who he is with, and the like. So such additional data might be used to create and modify questions. To illustrate, if a user is upset or angry and is requesting data the system might ask if this is related to his anger. If he is requesting such as travel information the system might ask if it relates to his current location, such as bus stops nearby. If he is with someone then the system might ask if a request relates to input from the other people.

In a further example a plurality of the said system and method might interact with each other, creating questions and attempting to answer them, and so creating, evolving, modifying process, actions, rules and the like. So to illustrate a first system might have a first database of knowledge and rules, and from this might request data from a second system, which responds with a question. The first system uses its knowledge, data base and the like to answer, or might respond with a question based on the second system's question. In some cases the two might get into a loop or get stuck where they ask each other similar things over and over without getting anywhere, so the embodiment includes a means to including data related to the questions to widen the data available. So to illustrate if a first system finds it is receiving questions back which it cannot answer or is responding with questions that don't progress then it might act in ways including asking a human, asking about synonyms of words in a question, asking about other keywords known or found to be related to the information desired and so on. Such questions and answers might occur relatively rapidly since computers typically can apply the system and method according to algorithms. So the various questions and answers can even through trial and error and brute force calculations often receive good answers.

A preferred embodiment relates generally to the internet and more particularly to search.

Search has a major problem in that the reasons people make web sites and the reasons people look at web sites are not always the same. Unlike in a shop where products are tailored to a usually known consumer, web sites have few ways to understand their customers. Usually they are anonymous and demographic data is difficult to acquire. Some progress can be made by advertising products based on key words on a web site, but this presupposes the web site administrator knows the consumer of those products. They might try and get a high ranking on search, on the basis that this will draw more people, but there is little understanding of what people are really looking for. To illustrate, a searcher might be looking for contact details of a business and get listings trying to sell him something. Such a general listing of results as in search would never be as useful as say in a store, or asking someone for information. This can be compensated for by the searcher looking through enough results but this is time consuming and is more like the equivalent of a store dumping its goods in a pile and letting consumers sift through it.

In a preferred embodiment searches can be organized according to the reasons people search. By organizing such results according to motivation, it becomes more synchronised with what benefits the searcher is looking for.

So to illustrate such benefits might be listed including by user surveys. Also search results can be analysed as to what the likely motivations were. Also known motivations of users offline can be studied.

To further illustrate then the reasons people search could be listed, and then results listed including according to said reasons. So there could be a first list of results that satisfy the reason of wanting to find where something related to the keywords is. To illustrate this might include contact details related to the key words search with, store locations related to products, and the like.

A further illustration would involve when, that the keywords are associated with a time period. So here various results that associate such as current events, historical, and a time line of such results could be shown to a user according to when they were posted or created, when the events in the result occurred, and the like. So to illustrate with “NASCAR racing” it might have results that include such as a timeline of racing history, biographies of drivers, when tracks were built, previous race results, races in current events and the like.

A further illustration includes the aspect of what. So here would be provided information about what the key words are, which might include definitions and what various objects are that are associated with the key words. So to illustrate with “NASCAR racing” it might have results such as web sites and documents on what it is, and definitions of what all the aspects of such racing including the kinds of motors, the sponsors, the drivers, the tracks and the like.

A further illustration would include the aspect of how. So here aspects of how things operated, occurred, were reported, and the like would be provided. So explanations of how machinery associated with the key words might be included, also the reporting or commentary on such key words.

So in the case of key words “NASCAR racing” it might have results on how races are run, how to get to the tracks, how to contact someone, how accidents might have happened and the like.

A further illustration might be the aspect of where. So this with “NASCAR racing” might provide where tracks are, where drivers come from, where the companies that make the cars and other products come from and the like.

A further illustration might include the aspect of why. So here such results on “NASCAR racing” might include why such as accidents happened, why races might be cancelled, why drivers retired, and the like.

So a searcher might select such as which, when, how, why, where, and the like, and so narrow down the search results into aspects he is more interested in.

A preferred embodiment relates generally to software and more particularly to search.

In a preferred embodiment search results might include such as excerpts from data objects. To illustrate, there might be a list of excerpts from such pages including where the keywords appear in one or more sentences. So preferably a user might click on or otherwise select such a sentence, a part of it, or an icon associated with it and the like, and thus be transferred directed, moved to the said data object.

To further illustrate such sentences might be made into a kind of story or text in which preferably such sentences might follow sequentially after each other. So a user might see a larger number of search results by preferably just seeing such sentences.

In a further illustration web sites and other administrators and creators of data objects might submit, create, select and the like a sentence or a preferably limited number of sentences to describe their site and on which preferably such search ranking might give some weight to.

In a further illustration there might be provided a list or other format of words and phrases that appear in a sentence with one or more key words. So to illustrate a searcher might use “NASCAR racing” to search and there might be found in sentences with these words (excluding common words preferably such as and, or, the, and the like) found in the text, soundtrack and the like of the said data object.

To illustrate then “NASCAR racing” might appear in sentences that also contain less common words in a first web site as “driver, racetrack, safety, purchase, weather”. So a searcher seeing these words would get a clearer idea on what the web site was about from seeing such associated words.

In a further illustration a second web site might have such a list of words appearing in sentences with both NASCAR and racing, but also other words and phrases that appear in sentences with at least one key word. So to illustrate, NASCAR might appear in sentences and other words in those sentences might be “schedule, timetable, weather, storms, injury” and so a searcher gets an indication from this. There might further be words also found in a sentence with the word “racing”.

Preferably such a format of search results might include a list of such words found in a sentence with the key words or at least within a predetermined number of words or letters from them.

Such a list might be as shown between quotation marks, it might be a numbered list, a bulleted list, an insert or in a frame, in a table, and any desired format known in the art.

Preferably a searcher could click on or otherwise select such an associated word and be directed to the section of the data object such as a web page where this is seen.

As a further illustration of the embodiment he might on hovering a cursor over such an associated word (like schedule on the first web site which was found in a sentence with NASCAR racing so is associated with it) or selecting such a word by highlighting it, putting a tick or mark in a box or other feature for indicating a preference, clicking on it or the like, he might see a selection of text around the said associated word.

So to further illustrate he might see the sentence that the keywords and associated word was in, and preferably X number of sentences before and after that sentence, to illustrate he might see 3 sentences before and 2 after it.

The number of sentences might be determined to be effective to be able to see what the content is about. Further, on holding the cursor over the word for longer or otherwise selecting or activating a control on it more sentences or letter might be seen preferably before and after the said sentence containing at least one key word and associated word.

Further, a user might select a plurality of such associated words including as said by clicking boxes and so might see text with said key words and the associated words selected. Such might not all appear in the same sentence and so the searcher might be provided such as the said X sentences before and/or after a sentence with the first associated word and a similar excerpt relating to other associated words.

So to further illustrate, a searcher might select a few associated words in a search result and thereby see excerpts relating those associated words with his selected key words.

A preferred embodiment relates generally to networks and more particularly to search.

Search on such as the internet is an inexact science. Often it is hard to tell from an algorithm whether a web site is relevant to key words or not.

In a preferred embodiment search results are varied according to a system and method so that different users receive substantially different results. Then this variation can tell what users think of various results because they react differently to different data. So thereby it can be determined a more optimum presentation and order of said search results and the like.

To illustrate, typically search involves some kind of monitoring of user actions, so as to determine what results they prefer. This can include using a cookie to track the user, such as Browser Helper Objects which are software tracking the user, using a toolbar such as with Google which also sends tracking data, and by hyperlinks in search results sending data to the search engine.

One problem is though that this data can only tell what the user did not what he thought. To illustrate, some links might be obviously such as spam blogs created by software, and the user is normally not bothered enough by them to complain. So because software is not good at finding web pages like this, search results can become clogged with undesirable sites.

So it is preferable then to devise a means so that the user's opinion of results he doesn't select is determined. This can be done by a system and method of varying results to users, and then determining from their reactions how these results are.

To illustrate, there might be for a set of keywords such as “NASCAR racing” some results which are undesirable for most people including spam blogs, personal pages and the like with no real information for a user. Ideally it would be good to rank these more lowly so users didn't have to look at them.

So since users can be tracked to some degree one can by giving different orders of search results to different users according to a system and method one can cause some users to be confronted with unpleasant search results. So if the results are bad then a user might not select any, and might exit the search engine. This would be information there is something wrong with those links.

So a first user might receive links that are known to be popular. A first link in that result list might be one that should be popular but is not for some reason. It might have a good Pagerank, get good traffic, even use advertising successfully but it might be a spam page and so gets traffic from people by accident. It is difficult though for software to determine this though people would do so easily.

So such a result might be provided at different rankings to see if people would try it. In an illustration the first page of search results might be all of this nature and if people consistently ignore them all and when to a second page then if it happened with enough people then with a certain confidence level it would be know those links were unwanted.

Of course consistently providing links to searchers would annoy them and hurt the search engine's reputation. But having these links at all has the same though a less effect. So by varying these results from very bad to very good the average effect on a searcher might be about the same but their reactions can assist for bad links to be determined and demoted.

So to illustrate such bad links might never be used, or if people look at them they come back to the main search page and look for another link. This would imply the preview of the page is misleadingly better than the web site itself.

So with good links these would likely be found and used even if they were demoted, because they were desirable. So in the case of someone looking for contact details they will usually look through a lot of search results to find a link like that. So if it is determined that a link is still selected at a good rate even of regularly demoted then it can be determine that it is a good link and later might be rated consistently much higher.

So these variations can determine from searcher reactions the quality of a link. Also good links might end up buried in amongst bad links perhaps several pages into results, where users might give up before coming to. This can be unfortunate as the better links might be there. So varying the order can bring these links up according to a system and method to a higher ranking and then if the selection of these improves enough then they might retain this higher ranking.

Another way to determine if people like a particular results is to show a preview excerpt, section of a result, link, web page, but instead of just getting this from the site, the data is downloading from a known location at a known rate preferably. So to illustrate this might include graphics, particularly ones not easily seen such as transparent GIF images and the like. So it is also useful to determine the speed they are downloading to the user at as it indicates their connection speed. If a user moves to examine a result or leaves the page of search results completely then these downloads will be interrupted and so that is a way to determine what the user is doing.

To illustrate such might also be provided in a pop up or pop under, with search or associated with any kind of web page. Since the data on it is being monitored in its download to the user, it will be known when the user closes the such as a pop up. If they are closed quickly then a pop up blocker might be blocking them or a user is not reading them, so advertisers are not getting their money's worth for them. If they close more slowly then it is more likely users are reading them or they are evading pop up blockers and the like.

So varying the content of these previews, pop ups, pop unders, ads on pages and the like can determine how much this affects the user. So to illustrate if changing from a first ad to a second ad changes how long they last in downloading then it is likely the first ad is being read. If there is no real change then it is likely neither ad is being read.

In another illustration if a first preview from a first link and a second preview of a first link are shown to different users and there is no real change in their selections then it is likely either both previews are bad and the site is spam, or the whole system of previews is ineffective.

So to further illustrate the embodiment a suspected spam blog might have part or even all of it shown to users in segments, excerpts, previews, and the like. If none of this results in users selecting the site then it is likely spam or not interesting to people.

In another illustration a web site might have say 10 different segments used as previews to various different searchers. It might be found that a first section gets more much selections than a second selection so this part might be determine to be used more often for users as the best preview. In another illustration the most popular preview might be not even associated strongly with the key words of the search and so this could be compared with key words in that first section and how that section works in a preview with those better fitting key words. So if the preview is more popular there than a second section it may just be the section is interesting regardless of the key words. If it with the better fitting key words is no longer highly selected when other sections are used in a system and method with different users then it might be determined that section is no longer current, fashionable, or it has significance only to the first set of key words even though there was no easily discernable relationship the software could determine.

This can be quite relevant though. To illustrate, a search of NASCAR racing might have a search result that scores highly with a preview section of high fuel prices. Now an algorithm is unlikely to determine this section would be a good preview for NASCAR but showing different section to users and monitoring their reaction finds a preview people like, and then this can be more widely shown to people and thus by this system and method results and previews can be improved. So once the preview that is best received is found the different sections shown as previews can be varied less, but they should still be varied to some degree so that information in a preview might become out of data or unpopular and might not draw people as well after a time.

The embodiment can also be used on such as web sites and other data objects. To illustrate, a web site might have a plurality of data objects such as images, video, flash, layouts, fonts, colors, articles and the like. So these can be varied according to a system and method so that the number of visits and revisits can be monitored. So by varying the said data objects as disclosed some people might be lost but the site might move towards a format, type that attracts more and more people.

Also interrupted downloads of such data objects can indicate when a user leaves a page and so by varying how long data objects take to download, when they start and end, where they are set, how large they are, how clear, what color, and the like it can be determined what the users like best by seeing which ones hold people the longest and make them come back.

The embodiment also includes using advertisements in similar ways. So a page might vary advertisements in any kind of format, appearance, loading time, color, font, wording and the like to determine statistically which ones are most effective. These can also be automated to some degree by an algorithm so that different formats of said data objects are presented, results monitored, people tracked and the like.

In a further illustration by changing said data objects on such as a web page these can also be ordered, designed according to known demographics to further narrow down the variations of users. So to illustrate if advertising and other data determines a kind of user and his demographic is good for advertising then variations around this kind of data object type targeted to this demographic might be used. Also different demographic data might be added according to a system and method because it might turn out that a different demographic is actually a better market, buys more, is more attracted to the site, and so on.

To further illustrate such a system and method might evolve said data objects to areas and types unforeseen by the administrators. Since the system can follow various cues from users, it could potentially change to any kind of criteria, data object characteristics and the like. So a site might start out on NASCAR racing and determine from user interest that gas prices are a better type of story to attract users and advertising revenue. So the said search results can also be used to advise site owners and advertisers what is popular for searchers.

The invention relates generally to search engine technology, and more particularly to the problem of determining what users of a search engine want to find, and how they use the search engine.

One of the main problems with internet and other search technologies is that it is a kind of bottleneck for a user. A person typically has a complex and rich idea of what he wants to find out, discover, search, and he must narrow this down into a format a computer can understand, typically in a set of key words. In the process of this narrowing down the programs associated with the search process usually only have these key words to work with.

Other solutions have been tried such as monitoring the user's actions in the past, to try and predict his future actions, habits, preferences. One idea is that if a first set of users find a particular link useful then other people are likely to also find it useful, hence it can be important to know which links the user selects.

One problem here is the situation is circular, since the user selects a link provided to him he is only really selected out of what people or software thinks he wants, and to this extent it is not known if he would really have preferred a link not even presented to him. So the fact that he selected a provided link does not necessarily mean he would find it the very best one on the internet.

This problem is exacerbated by the fact that many searchers only look at the first page of results and might accept an inferior link rather than hunt through more selections. So this gives a further false impression that users are satisfied with a given link just because they selected it.

It would be useful then to ascertain more information about user's search and other browsing requirements.

The invention contemplates using a system and method to present different search results to users than a search algorithm or other search methods might indicate and then monitoring the user's activities. In this way by experimentation, trial and error, the more difficult to determine desires of the searcher can be found.

In a preferred embodiment a variety of algorithms and methods might be used to select search results. Google might use Pagerank, Yahoo might preselect categories of links on the basis of such as location, type, popularity, and so on. On this basis they might know the user's level of satisfaction with the search engine by various methods including monitoring with a cookie, having search links point to a proxy, using Java, Browser Helper Objects, Active X to send to the search engine reports on their activities.

The search engine model however is ultimately multiple choice, in that the searcher has to choose from the links offered, rather than an attempt to create a data source that meets his needs directly.

In a preferred embodiment a first set of search results might be selected to present to a first user. This user might be known in the sense that his past browsing, search habits and history might be known including by the methods disclosed herein. To illustrate the invention more clearly it will be presumed that no history is known of the users, and that it can be determined which links they select.

One advantage of the invention, as will be shown, is that statistical methods can determine with good accuracy how people act from a relatively small sample. This can be seen with polling in such as political approval ratings.

To see then how users might react, a choice should be given so it can be seen user characteristics including the different types and demographics of the users, and how these groups act in different situations.

To illustrate then a first set of key words has a first set of different alternatives of search results. These different alternatives are intended to mean that different users might put in the same key words and receive different search results. So a first user might receive a first list and a second user might receive a second list. Different lists of results might have an overlap in that one or more search results might be in both list.

To clarify further we might assume the users only receive 3 pages of search results each. Often of course they might receive more or less than this but to illustrate the invention the system and methods can be applied to these 3 pages, though the scope of the invention will be shown to be much greater.

So assuming that three pages of results are given to users for a first set of search key words these can be changed in order according to a system and method and then it can be determined approximately or specifically how the users react.

Approximately might refer to an incomplete set of data that some of the user's actions are known but not all. Even incomplete data can be used to give some indication of user actions.

So assuming a set of searchers use a first set of key words then one might as a first system and method randomize the order of the links to different users. A first user might get a first order of the links and a second user a second order and so on until in this case all the different possible orders of the links are used.

Then the links users select can be monitored and thereby the effect of a particular link being placed higher up in a list can be neutralized. So if a first link was popular for users no matter where it appeared in a list then it would be likely such a link was of good quality for those search terms, and might according to a system and method be placed more highly for searchers in the regular search engine use.

One advantage of the invention is that relatively small experiments as disclosed can be performed so as to not annoy searchers too much with bad results. So instead of completely randomizing results the search list might be partially randomized, or reordered according to an algorithm so some users would see some less relevant links while others would see more relevant links that would not have been found to be useful by current algorithms in the art.

So partial or complete randomization of search results to a sample, set, group of users can improve the quality of the search results for a given term. While some users might be unhappy with irrelevant results they today in the art often have to put up with irrelevant results from algorithms anyway.

In another illustration of the invention demographics of the users can be inferred by selective experimentation with the search results include by varying their order, their placement on a page, their emphasis such as font type size and color, and associating imagery.

The general demographics of the population is reasonably well known, but it is harder to know how these demographics interrelate to particular search enquiries. It is one thing to assume a group of the population has a particular political leaning but another to assume that because of this they would react predictably to a particular set of key words. On the other hand though they might.

So experimentation with variables generally in search results can also be applied to other data on the internet such as web page presentation and format. In a sense then people search for content on the internet but when they go to a link they are still searching, and a web page is searched itself for relevant data. So the invention contemplates varying any characteristics of data on the internet where user behaviour can be monitored. Such monitoring might include data in cookies where a first group of users might see different formats and content on a first web site and their behaviour is monitored compared to a second group who sees a different format and content.

The search engine results then represent a good medium to illustrate the inventive concept. It might be presumed that known demographic groups use the internet and defining how these groups act is useful for actions including placing advertising, pricing ads, determining what content to display, what format is most appealing. Further however the internet itself and other factors might create different groups that act in a similar way to each other, either unconsciously of each other or having some sense of acting as a group.

So in a sense behaviour on search results need not conform just to known demographics but should be more open ended. The system and method including randomization of results is likely to result in some links being discovered to be popular even though no algorithm might have predicted this. Further, such links might be popular to groups algorithms might not have even known existed.

So assuming a link is more popular than expected it further needs to be determined a means to discover who it is popular with, whether some or all of them act as a first or second group, whether they act as a group with or without realizing others act like them i.e. they realize they are a group.

So typically for a first set of key words a plurality of links might be found to be popular, and this process can be repeated for other sets of keywords including those sets which are similar to the first set. Such other sets might have at least one word in common with the first set, include synonyms to at least one word in the first set. Various systems and methods can associate other sets of key words with the first set and the various processes described herein also might find links which are surprisingly, unpredictably popular.

So preferably the search engine, web sites, data sources, on the Internet or indeed any network of computer related devices can be experimented as disclosed so that user reactions are monitored.

Further one might find a first group of key word sets which are placed in a group according to a system and method that suggests they belong there. Such a system might be that they are a group of key word sets that share a common key word, so that a first group might consist of all key word sets that share a first key word and a second group those that share a second key word. So these groups can further be explored by varying parameters of data displayed to users including the said order of search results, font types and sizes, and other format and content variations.

It might then be determined that particular key words have a popularity with a first group of users but are more popular when associated with a first set of additional key words than a second set. So this further implies that a first group is interested in not just that key word, but that other keywords more specifically define their interest when added to a first keyword. So then this might be represented graphically, in a matrix, algebraically, according to an algorithm where various key words represent a group interested in them, and then further key words added to the first key word according to the level of popularity can define boundaries of aspects of the group. So adding more keywords to the first key word at some point will cause interest in that link to lessen and so one can by the said variations determine a group of users who are interested in a group of key words.

One advantage of the invention is these results can be found without preconceptions of what these users and what they like, rather these groups of key words can be found by varying the various format and content provided to users.

In a preferred embodiment such variations might evolve into specialities and further sub groups of format and content so that users even if they are not contactable can tend to move toward the format and content that is evolving to their needs.

Such an adaptation of the invention is particularly suited towards such content as portals, web pages, forums, blogs, magazines. The said format and content is varied according to a system and method and the resulting changes in usage monitored. One way might be that users need to register and so it can be seen how often they log in and determine whether their interest is increasing or decreasing. Another means would be to monitor cookies to see how often users return.

So variations might be used to present different content including different genres, fashion, known group types (including known demographics such as Goths, teenagers, singles, political leanings) and the user reactions monitored. So a first user might find that the content and format changes as he visits and since the variations are occurring he might find it is either evolving more to his preferences (resulting in more visits) or moving away from his preferences (resulting in less visits). So while such variations might lose some customers, people are lost anyway for different reasons. Users might also be able to see different links of different variations and look through different ones. If they find one they like they continue to go there, and the said monitoring uses this data to continue to evolve the format and content in a first direction. If some users like it less and less they might find another variation and so move to a different one.

If a particular variation started losing too many users then it might backtrack toward earlier variations. So potentially fatal variations can be avoided.

One advantage then is that format and content can be found that users like without anyone having known beforehand what that format and content is.

In a similar way different search results might be further seen to appeal to different groups. Further as variations become apparent in that groups of different types and preferences might be using the same key words then a dilemma occurs as to how to order the search results to appeal to all groups. The invention contemplates providing to users different group selections so that a first group might find that even if they cannot define themselves accurately or a definition of them might not exist, they do act as a group and so a search engine, forum, web page, blog, that caters for them is preferable.

So to illustrate the concept with a search engine a number of groups might be determined to exist with various key word sets, and such groups might be displayed to users. A person might select a first group along with their key words, and results might be ordered in a first way, and formatted in a particular system and method including font, color, imagery.

A user might find over time they belong to a particular group when searching on a particular subject, and so might select that group designation, and further might add this or allow this to be added to a profile for them. Such a profile might be updated and kept according to a password, username, cookie, java applet.

Such groups might further receive names, designations, descriptions, statistics, so that users might read them and decide whether to explore using that group.

Preferably advertisers might se any of this data to target their advertising, bid for advertising positions and key words.

One option for users might be to go back to a previous time in the group. As a group evolves in their interests through the said variations in format and content it might vary too far away from the group's preferences, and so users might select it goes back to an earlier time, perhaps before it strayed into an unpopular variation.

To further illustrate, evolutionary algorithms and systems and methods can be used in the said embodiments. So people going to such as a website, provided with search results and the like can be provided choices different from at least some other users, and since they would tend to react differently such choices can be used to evolve better searches, web sites, data objects and the like.

To further illustrate any data objects on a network including the internet can use the system and method disclosed. So songs might evolve in this way by giving users different versions, and based on what they prefer keep offering more variations and so this would tend to evolve music that was more popular. Those variations less popular might receive less votes (and of course all the illustrations and embodiments can use voting to include user's choices and feedback with said variations), get downloaded less, get bought less often and the like. So a data object might also include a business system and method where users might subscribe to not just one data object such as images, movies, flash animations, music, web sites and the like, but to the offered variations. Then to illustrate a user might not only have a right to download the data object as a purchaser but this might also include renting such data objects, and further rights to substantially some or all variations.

So a song might start out in a first form and by the said changes, which could be done by artists, software, administrators, judges, and the like, it could evolve into something different even including other aspects of data objects such as adding flash, video, imagery, and the like.

Such data objects might also be traded on such as peer to peer, and the ones downloaded or shared the most would give feedback as to the direction of evolving them. So to illustrate if a video evolved in a first direction and then user interest waned then it might backtrack to a previous point or variation where user interest was higher and provide more variations from there.

To further illustrate such data objects might also include stories, plays, screenplays, novels, short stories, reporting on such as current events and the like. So the evolution of such data objects might instead of just like a Wiki where people edit stories, the said data objects are edited according to a system and method based on discerning user interest and intent.

So in such as a hunch engine it could be adapted to the embodiments disclosed. Other means to discern user interest and intent are included. To illustrate comments might be scanned, read, assessed, and the like including by software looking for positive and negative words associated with such as a thread on the data object, also voting by users, the number of posts by users, increases and decreases in posts measured against new releases of variations, and the like. So these and other systems and methods can be used to discern user intent.

To further illustrate search results also can use these system and methods including the said evolutionary algorithms. Also such results in search can be coordinated, added, used with data object evolution and changes. So users might be monitored with their search selections and also their movements in data objects including such as web sites. So as changes are made to such as web sites and user interest increases then this data can also be used to improve the said site's rating, ranking and the like. So to illustrate, 100,000 sites might be monitored as disclosed, evolved according to user interest, demographics, fashions, different seasons, according to current events, and other factors which can alter which variations they prefer. This data is useful for search so that such evolutionary data objects could be such as a selection in search, to search for data, uses, information in these kinds of data objects and so the rating of such sites with users could be more directly used in the said system and method to give sites a ranking in search including how high in a list they are provided to a searcher.

Also of course a more general search might include such sites and data objects, and so the evolving rankings of such sites would be preferably then used with other systems and methods including such as Pagerank, tracking users and the like.

In a further illustration stories, plots, screenplays, serials, episodes could also offer variations to users. So a story might offer such variations in it, and users select those they prefer including such aspects as more action, violence, romance, erotic, sports, setting of the story, which actors used, evolving a character of someone in the story, and the like. So within the constraints preferably of a consistent storyline such changes can evolve the show, data object and the like into something more of interest to viewers.

In another illustration the system and method can apply to games. Aspects of these including avatar design, scoring methods, numbers of addons (including such as health restore, shielding, armour for characters, stronger or weaker weapons, new weapons, new environment, new scoring to determine when the game or round ends, altering such as gravity and the like), number of players allowed, kinds of texturing such as with graphic cards, and the like. So variations of these would be offered and users can select whether for their own use (including such as new avatar designs, new gun designs, new implements), for a game parameter (including such as what is necessary to win the game), classifications of players (including being promoted to a higher class, having a ranking system or honours such as master, general and the like), and so on. So users according to the system and method evolve the said games and other data objects into a more pleasing format and the like.

In a preferred embodiment data objects including such as web pages a user visits might be monitored, tracked and the like and search words in them give lists of how those search terms rank in search results. So to illustrate, a web page might be by a system and method be determined by a search engine to have a first ranking for a first set of search words (typically found in the data object) and a second ranking for a second set of search words. Such a data objects might even have larger number of sets of search terms so that a user might see a list of such sets of search key words and how the data object such as a web page ranks according to each set. So to illustrate a user might visit a web page and be provided with information that the web page is ranked highly with a first set of key words he is interested in, to illustrate as “NASCAR racing”, and so he might be provided with a list of search results for NASCAR racing and might see the site he was at on that list, and then might be able to visit other sites on that list. So the embodiment includes a means for users to find out if a data object is ranked highly according to a system and method including such as pagerank and further to see how the data object is ranked according to other criteria including other search set of key words.

In a further illustration the top 10 search results relating to a data object such as a web page might be recorded, determined, saved and the like. So the various sets of search key words on such as a web page might be recorded, stored in a database, be retrievable and the like if the data object ranks in the top to for a particular set of key words. 10 is just to illustrate the embodiment not to restrict it to a particular number.

In a further illustration a user might be able to see whether data objects he visited, read, heard, watched, acquired, linked to and the like were highly rated and it is likely that if he looked and the like at higher ranked data objects for such key words and other search criteria then he might find data objects of higher quality, more popular with others, more interesting, with higher traffic and the like.

In a further illustration the embodiment includes a history of the user's interests, surfing, history, track record and the like in terms of search keywords. So say with a data object including such as a web site each page in it has 10 sets of keywords which are recorded, collected, determined according to a system and method which are then preferably search and a list of search results of those search terms is created, provided and the like. In an illustration there might be 10 sets of keywords from a page and the top 10 search results relating to each of those sets of key words in created, recorded, saved in such as a database, and the like so then if a user visits 100 web pages then this would give perhaps 10,000 related web pages as search results in various lists, databases, and the like which give information on what the surfer has encountered, what he was interested in, what he like, what advertisements might target the user better, what other data objects might be provided or otherwise suggested to him and the like. So such search results and data from them according to a system and method could then be suggested as an area, interest, subject, hobby, topic, and the like the surfer could visit, read, watch, hear, buy, rent and the like including such as a list of bookmarks as a trail, list of objectives, a suggested route a surfer might take through such a list, and which further might be seen by the user as related to his interests, hobbies, history of interacting with data objects and the like and as a user browsed and the like these then even more would form a trail, be provided and the like around his surfing and other activities so he can see like a cloud of related links around him as he goes and can try these.

So to further illustrate the embodiment the user would be provided with further means to find and explore data objects like the ones he investigated, examined, used and the like before. In a further illustration the embodiment might develop like trails, branches, roots, a cloud, zones, and the like including as seen in a tree. Where a user is he might see other trails as roots and branches as alternatives to try moving, browsing, surfing and the like going forward to new data objects and back relating to older ones even from a long time ago such as days, weeks, months and the like. So if he is heading to new keyword associations these would be such as branches and if he is leaving old key word sets these are preferably roots. So he might try and cover everything of interest in a subject including by checking the search results provided and so can cover all kinds of unusual and hard to find associations with key words, try different subject and explore links between them.

In a further illustration the user might have his surfing, browsing, activities and the like reanalyzed, monitored, determined and the like over time to see if new links and search rankings have changed. So to illustrate he might have been provided with said search results but over time the search results and rankings might change there might be new data objects that rank higher than a determine amount, and other data objects that once ranked lower might now rank high enough to be provided to a user. So the user might be provided with updated information in relation to his activities even from his past browsing and the like.

In a further illustration a user might see or be shown gaps, deficiencies, inaccuracies and the like in his activities, surfing and the like of the said data objects. In a further illustration he embodiment might include a means to give ratings, rankings and the like of data objects such as web sites and might also include the determination of awards, medals, honours, praise, prizes, and the like.

In a further illustration the embodiment might include a means to track popularity, use, visiting, statistics and the like of data objects including such as web sites so he can see what sites are popular. So if a data object is associated with sets of key words and these provide a list of search results so that a particular web site is highly ranked with a plurality of sets of key words then he might conclude the site is broadly appealing to various key words and hence is highly ranked according to a plurality of features, topics, subjects and the like.

In a further illustration he might be provided data showing that the data object and its sets of key words and other criteria for search might vary in their rankings including such as seasonally, according to current events and the like. So to illustrate a site might vary its ranking from a first rank to a second rank over time with regard to the key words “NASCAR racing” and also from a third rank to a fourth rank over a time period in regard to the key words “holiday tourism racetracks” and determine that the site is seasonally popular for holidays by people interested in NASCAR and advertisers might use such data in determining process and placements of ads.

In a further illustration advertisers might use key words in a data object to determine which ads to place there, and so if a site has rankings according to a plurality of sets of key words then it might have X % of ads relating to a first set of key words and Y % relating to a second set of key words and such percentages might change over time as the said site rankings change. Such rankings would also include systems and methods used by such as Yahoo, Google, Microsoft and others search engines, including such as pagerank.

A preferred embodiment relates generally to software an more particularly to the Internet.

Hyperlinks are often used on the Internet but they have many shortcomings. Sometimes a link is broken when a site no longer exists, and also people sometimes don't update links such as on web pages to keep them interesting.

In a preferred embodiment a link is provided which has a preferably unique identifier and preferably a presentation, graphic, text and the like which can also be altered by such as an entity external from the web site.

So a first link might link to a first entity, and has an identifier which is preferably unique to that link, at least unique for the first entity. So to illustrate a link might have an address it points to such as http://entityname.com/data, the data preferably identifies such as the user who made the link, the web site or other document it is on, a subscriber, and the like.

One advantage to the system and method is such links can be used including by the said first entity to provide useful content for viewers and users of the said data objects including documents, web pages, mash ups, images, movies, flash and the like.

So a link might be connected similar to an advertisement in that a viewer or user might see a data object such as a graphic, cell table, frame, and the like in which the data is preferably downloaded from elsewhere. Preferably also the said data object can be clicked on, hovered over with a cursor to activate other features including to preview a link, go to the link address and the like.

So to illustrate a first user might provide say 5 links on a document say a web page. Each preferably has a link that points to an entity, to illustrate here they might all point to the first entity. Each preferably has a unique identifier and preferably to illustrate each can download a data object from the first entity including such as an image, flash, movie, text, banner, ad and the like.

A user then can design at least part of said document by including such links, which can then provide data which can change dynamically according to various criteria. Instead of the usual practice of linking to a second site the entity links can also route, redirect or otherwise direct someone who clicks on the link, previews it by placing a cursor over it, and the like to that second site. The entity can also monitor how often said link is used, and this gives advantages including if a viewer clicks the link and then clicks on an advertisement or the like on the second site then the first site owner could receive a payment for such a click, thereby making more revenue.

Such chains of entity like could be as long as desired. A surfer or other viewer might go through a succession of such sites using such links, and monitored by such an entity, and when clicking on advertisement links revenue could accrue to various site owners according to a system and method such as apportioning the revenue.

In a preferred embodiment such links would also be less likely to become broken because the said entity would detect this, and could act including such as looking for the second site's changes so as to fix the link reporting the link is broken to the first and second site administrators, replacing the link with a similar link to other content, and the like.

Preferably also such links could display content on a first site so as user could have a site substantially able to be redesigned by such external entities. So to illustrate a site might be about NASCA racing and have 5 such links. These might provide text on this subject, video links on it, audio downloads, links to related content, forum entries and the like so a first site might be substantially run, updated, edited, and the like by the said entities and the first site administrator might also receive income from advertisements on his and other sites linked to.

To further illustrate when the entity had a plurality of such sites the said content could be provided in a more organized manner. So a sufficient number of such sites might provide an encyclopedic like knowledge on a subject including such as NASCAR, and the site operators have to do little to provide such content, and even the bandwidth for much of the content might come from external servers.

A viewer might not realize this because the said entities could make such content look like it is tailored to the first site in such as font, colors, names of the site and administrator, adding comments and the like. So in a way similar to a spam blog such sites could operate but the entity preferably provides legitimate content.

Further such content and knowledge of the entity's sites could cause such sites to get a higher rating since such links would be similar to a higher Pagerank, the content would have a good reputation, and the like.

Also advertisers would do well from such a system and method because ads could also be provided by the said entity, tailored to particular content, they could review this content and adjust their ads to it or vice versa. They would know more about how viewers got to the site, and where they went, if they decided not to click on their ad, and clicks that came from other sites might be seen as less likely to be bogus.

Such content could further be changed, experimented with to improve traffic. So if a first site had low traffic with the said entity's content it could be changed, edited, and so on to try and increase the traffic preferably so the site administrator didn't have to do anything as the entity could do all this will the links.

Other links could be provided by the system and method. A link might direct users to a high rated link on a topic in a search engine, perhaps related, perhaps on a subject known to be more popular and it would appear as if the site administrator had provided such a link and perhaps data objects related to it. Then other such links might be provided with other ranked links including with the same or similar keywords and it could be noted which links users preferred. So as this data was analysed it would be determined which of this links was most popular and hence such links could be placed higher in search engine results since the system and method might also determine which links people like.

Such sites then might be changed dynamically according to effective criteria including seasonal changes, fashions, current events, and the like so viewers might remember if they go back there the content is updated. Often viewers go to a web page, and having read it assume it is not likely to be updated. So such changes would make repeat traffic more likely.

As such traffic increased the entity could represent such traffic in a net like representation where nodes might be the said data objects including web pages, documents (such as Word documents, PDF files, and the like which might be used occasionally even copied by the links could still download, use, access such entity content when networked), movies, flash, music and the like. So a user might have a multimedia file such as a song, which when used on said network including the internet might download additional data on such a link. To illustrate a song might download different imagery including images of an artist, images relating to the music, advertising, links to other data including songs, music, movies, special offers, web sites with content including related to the song, and the like.

So such a link might be included embedded in said data object. If said data object is copied then such a link might be updated by a system and method so it regains preferably a unique identifier. So a song to illustrate might be downloadable, copyable, and each time the identifier preferably also changes and it might be legal to use the copy as long as the said content is included such as advertising at that start or end of a song, ads seen while playing, and the like.

the system and method further offers a way to offer piraters of content a way to use said content for cheaper, and offers them incentives to become legal users.

Similar systems and methods can also be used for programs, video, games and the like. If the entity can provide such content as the game is played, program is run, video is watched and the like then some revenue and contact can be made with the pirater and either a legal arrangement arrived at or a means to persuade them to become legal, or at least a means to raise revenue from their use of the various data objects legal or not.

Urls, links, etc replaced with, augmented by, etc search link format. For example like hyperlink where you click on it and it has search parameters that find site, movie, web page, etc. This can be as efficient as normal links and it can also search for context to the page, roots, branches, a hash of that page to prevent broken links, hashes of part of page, etc.

For example link goes to search say google with keywords and displays results, or can display one result. Should work the same as links usually if terms are clear enough.

Links can be supplemented to pagerank, where the wording of a link is searched as pointing toward an interesting link. For example keywords in a search engine might be found in the hyperlink wording, in the sentence containing the hyperlink, etc.

Look at a hyperlink on a first site, and work out what key words would make that link come up first say or near the top in a search result, and which appear on the first site. So those key words can be associated with that link. So a given link can be associated with those search key words and people can bid on those key words to associate with advertising. The more pages that are associated with that hyperlink the more can be looked at with their key words that deliver that hyperlink as a preferred result. So one gets a list of key words that associate with a given link, which people can bid on. Also if people put in those key words then the resulting hyperlink is associated. So the hyperlink site might have key words in it similar to those in the web pages that link to it so it's likely there is an association of content.

Search blogs where stories are written with search links, with a keyword or identifier connecting to particular stories or articles, and smaller identifiers as more general links. So one can click through stories and get randomized links, most popular, most read in other systems, etc and so other than just one can get to have their opinion, and links might change so arguments can be followed like many are arguing with one another. Also search can show links referring to the current story being read.

In a preferred embodiment search including the use of such as bots, programs and the like interacts with such as sites, web pages, and those files and data typically indexed, stored, accessed and the like by search engines and preferably and retrieves, records, gets and the like data including such as web pages, documents, images, data objects, text and the like and preferably caches them on such as at least one server, memory storage, optical storage hard drives and the like. Then results of searches can be shown including as previews of parts of this data such as a group of sentences around key words and clicking on them takes you to that part of the page. So this can be like an abstract or summary of sites where one sees extracts like this and so can quickly see the gist of a site. So might have multiple sites in results and each can quickly be seen as context.

To illustrate, a user might use a set of key words and receive from a search engine a list of search results. He might click on or otherwise select a first search result and he can be taken to the section of the data object where the preview data is located. SO if a preview had such as X number of sentences preferably including the key words from the search then he might be provided with that part of the data object including such as a web page which shows that preview instead of having to search for this preview himself. Since such data objects can be large the embodiment saves the user time and energy. Preferably if the said preview data is from multiple locations in the data objects he might be provided with a view of the said preview in a first location and be further provided with a control including such as using a key press (such as tab) a mouse click such as right hand click, and such controls (which might be any desired control of keys, clicks, voice recognition and the like) might move or otherwise provide the user with a view, to listen (in the case of sound data objects) see (in the case of such as vide) and the like of such parts of the preview, and so the data object might skip those parts between he preview section by using such controls.

Also sites can be shown according to their search rankings for other key words. So a site might have high rankings for 10 sets of key words and so 10 excerpts might be shown with the context around those key words sets. So one might see the equivalent of say 10 lines and see what is considered popular or useful about that site. So a site might have an advertisement for it like this, showing what is considered good about it in terms of search engines, excerpts and rankings. Then they might work on this with the objective of making better considered abstracts with working with multiple rankings not just one. Then abstract might attract ads and so people might bid higher for abstract result.

So user might see abstracts in relation to first key word set and then surf to second key word sets and see what abstracts there are there. Not as good for focused search but better for wider range.

In a preferred embodiment there is provided a means to increase interactions between computers, networks, users, servers and the like rapidly, quickly and the like including by using exponential, logarithmic increases in numbers, connections between computers and users and the like.

In an illustration a first computer might pass data, instructions and the like to say 10 other computers, and each might further pass such code, instructions, data and the like to a further 10 and so on as the number of computers and users contacted, urged to do a task, sent code, sent instructions and the like.

In a further illustration responses to an alert, condition and the like might use the embodiment including in directing such as patches, virus definitions, data objects (including such as movies, tv episodes, music and the like), torrent uploads and downloads, peer to peer and the like.

In a further illustration a file might be sent out between computers in this way so as to quickly be received by larger numbers of computers and related device. One advantage of the embodiment is it provides a means to not necessarily require central servers where users, computers and the like all have to receive such data.

In a further illustration a first computer might send a file to a first set of computers (say for the purposes of illustration not to limit the scope to 5 per set) and each computer in that set send it to a further 5, and so with 30 such operations the number of computers with the file could be 5 to the power of 30. So such code, data, and the like can be passed on, distributed and the like without necessarily having a central server.

So in a further illustration users might receive a file as disclosed in large numbers relatively quickly by having such a structure available in the embodiment.

Might quickly send out instructions and responses between computers so tasks get done and reported quickly and once instructions are done new instructions sent out and they in turn spread quickly. So tasks overall can change quickly in response to unexpected changes and np random successes and failures.

In a preferred embodiment comments, posts by people on such as forums, chat rooms, blogs, and the like might be searchable and rank by such as a search engine.

To illustrate, a post that was linked to by a plurality of other posts might be ranked higher including like with Pagerank. So the more times a post or comment is linked or replied to by other posts or comments the higher its ranking might be.

In a further illustration comments might include a means to determine how often they are read including such as the software showing on the site, web page, post and the like how many times it was accessed, read, hit, and the like.

So more popular posts might be ranked higher in search results.

In a further illustration a comment or post and the like in a search result might also be replied to, quoted, commented on and the like. So a first user might post a first comment which might rank highly according to a set of key words. A second user might read this and post a reply to it, quote it, and the like and so the first comment might increase and decrease its ranking by people finding it and responding to it in the search engine results.

So to further illustrate, a search engine can complement the use of forums, blogs and the like where people might read comments in search engine results, post replies there and might not even go to the original forums.

In a further illustration a user might see a tree, list, and the like of other comments related to, on the same or a similar topic to the first comment, be able to go to the forum or blog, or the search engine might cache or otherwise store such comments as well.

So to further illustrate a first forum might have a first tree of comments according to a first topic, the tree structure typically formed by replies of other commenters forming a kind of branch structure often seen on forums. Such comments might appear in said search engine rankings including according to key words used, tracking or otherwise determining what a user looks at, reads, surfs and the like to show them various rankings of comments, and the like.

So to further illustrate a first tree of comments from a first forum and a second tree of comments from a second forum might tend to merge, form into a single tree, form other tree spinoffs and the like. These might be viewed and interacted with by the search engine so people can see which comments are popular, new, controversial, highly ranked and the like. So since the highly ranked comments tend to be at or near the top of the results people tend to read and reply to a higher quality comment and so if they replies are also good enough to be highly ranked they might in turn by replied to or quoted and so the thread might continue, and if their reply is not well ranked then it might be forgotten or drop off the tree after a determined cutoff point. In a further illustration a user might post an article as a reply to a comment and so a comment can also be like a post of a new topic. So the embodiment includes a means to search by comments instead of just by topics and articles and the comments, trees, conversations, arguments, debates and the like can be followed, shown, ranked and the like rather than the topics and articles being the focus.

To illustrate, the search would then tend to show people who commented well rather than topics that were ranked highly. So often a topic might be such as current events and people might not comment well, troll, argue and such comments would normally be unpopular and often many such threads and trees occur on blogs and forums.

In the embodiment however the emphasis can be on the commenter and a comment can be highly ranked even if the topic might not be highly ranked when said topic (which might include the trunk or start of a thread of tree of comments) might be ranked also in a search engine but preferably separately from the comments.

So to further illustrate the embodiment encourages quality conversation, argument, debate and the like and people searching might find their key words are directing them to highly ranked such conversations and arguments, which may be more interesting than topics which might be poorly debated and commented on.

In a preferred embodiment data including such as files, code, programs, and the like each preferably has at least one identifier associated with, connected to, merged, with, related to, adapted to and the like it. Such an identifier and the said data are preferably digitally signed. To illustrate, a user might have such data he wants to be able to find, track, locate, and the like on a search engine including such as Yahoo, Google and the like. So such an identifier is created, modified and the like including by making a hash of the said data. Then preferably the hash or other identifier is used to locate the said file in such as a search engine. To illustrate, a data object including such as music, text, document, video, image and the like might be provided in such as a ftp site, web site, and other locations on the internet files are available.

The file might further be named by the hash. To illustrate the hash might be such as aopijf908u98jweouijf098 and so the data object might be named such as aopijf908u98jweouijf098.jpg.

So the use of a hash or encryption of the data has advantages because the name can be searched for and when the data is located it can be hashed or otherwise a system and method is used on it and preferably this derives, calculates, determines and the like the said identifier, here illustrate by but not limited to a hash.

A further advantage of the embodiment is files, data and the like having been named or otherwise having their hash or identifier associated with them it is easier to check if they are genuine, infected, tampered with and the like.

A further advantage is that users might search for the data and so it can be determined if it is available where it shouldn't be such as pirated, copyright violations and the like.

In a further illustration data might further include such as comments on such as a forum, blog, chat room and the like. So a first user might post text including such as a comment and a hash might be provided by software preferably on such as the web page he posted on. So a user might have a means to note, record, save and the like such identifiers including such as a program which might track, monitor, and the like the user's action including to provide this record on such as a web site, document, blog (which might to illustrate provide a record of the user's posts), and the like.

So a user might have such a means to record such identifiers and they might further be published on such as a web site associated with his identity and further there might be provided a means such as a search engine to search for such identifiers and thereby provide a list of the data include here illustrate by comments, posts, writings, essays, audio, video and the like. The embodiment includes a means to make it hard to spoof such identifiers. To illustrate, such data when found to be named or otherwise associated with such identifiers might be simply hashed and so a fake segment of data such as made by a spammer or hacker would not have the right hash.

In a further illustration a search might also include hashes relating to the user, including such as a hash of his avatar, nick, programs that might run associated with the user, animated files including such as GIF or flash or shockwave, and the like. So a user might have such an identifier and so a first user might search for this identifier such as a hash on a search engine and see posts, comments, a trail, records and the like of the second user's activities. This would also be hard to spoof by a hacker or spammer because such a search might be further restricted to such as sites that the second user might register at and the like so if a third user stole the second user's identity hash then it might be only used in sites where it was not registered and such might be filtered out of search results.

So a user has a file he wants to have number and hash is made of file and this can be identifier or other number can be. Then copy of file might also be digitally signed and so it is harder to find another file with same hash. So a searcher looks for results and those results are also checked for their digital signature. This can be done by search engine, by spider visiting sites. So a person might have a site that links their comments in forums by showing their hashes and so these hashes placed in search engine come up with these posts. Also images can have hashes and so people hash their images for copyright and so certain hashes might be set to be not downloaded in search if forbidden. A copyright holder might post a hash as his like owning a hash and proving it by submitting copyrighted work like image or movie. Can also be song or even score of song.

Hash might have large number of bits for differentiating them and preventing duplication. So people might set up web site or document with hashes and these original files are downloaded from host or search engine. Site might also be listed there or hashed for easier downloading. Because of this no viruses.

Also code can run by hashes sequentially given so this code can be downloaded from search to make custom program or to ensure program is safe.

Can be like shorthand or compressed because just hashes might appear on sites or documents and these are searched. Also can hash quotes, parts of books, typical phrases so that instead of quoting them they can just have their hash.

Also can have hash and algorithm dictionary for compression so that more popular hashes can be represented by smaller identifiers like Huffman. Also actions and sequences of events can be hashed so a set of instructions like setting up a web site, formatting a document, artificial intelligence like hints on how to do something might have hash or identifier plus differences. So like DNS where a hash sent might come back with the current identifier for it, so can use these as friendly names. These can also be signed so that no fakes of numbers to act like spam.

It is intended that other devices that have a substantially similar function and/or that the invention can be adapted to work on, function with, etc be included within the scope of these terms. Of course the scope of the invention is defined in the claims, and any language that indicates otherwise in the specification is unintentional.

Further aspects of these inventions will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

These embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

When the exemplary embodiments are described with reference to block diagrams or flowcharts, each block represents both a method step and an apparatus element for performing the method step. Depending upon the implementation, the corresponding apparatus element may include being configured in hardware, software, firmware or combinations thereof.

Computer storage means includes storage media which includes volatile and nonvolatile, removable and non-removable media implemented in any method or technology for storage of information such as computer readable instructions, data structures, program modules or other data. Memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the invention.

The invention where applicable typically includes a communications means that allows a first element of the invention to communicate with a second element. Communications connection(s) is an example of communication media and a communications means. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Embodiments of the invention where applicable, may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

The logical operations of the various embodiments of the invention (where applicable) are implemented as a sequence of computer implemented acts or program modules running on a computing system and/or as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

By “any possible function”, “algorithm”, “system and method” includes meaning any possible algorithm, multiplier, quotient, power, ratio, sum, difference or other possible mathematical function between variables (enumerated and/or un-enumerated), including, but not limited to, the length of time spent inspecting an article, total length of time spent inspecting articles (matched or un-matched), position within a list, articles listed before and after a particular matched article, whether or not an advertising banner was clicked on, and/or whether an article was printed, uploaded, downloaded, viewed, listened to, emailed, faxed, inspected, responded to (such as by answering questions requested by an article or its associated web site), loaded client-side or server-side, or saved to a disk. These apply either to the article or anything associated with the article, such as its URL or other location.

I claim:

1. A search engine,
wherein a document ranked in a first search result according to a first set of keywords comprises a second ranking according to a second set of search key words.

1. A search result according to claim 1,
wherein a second set of key words provide a second search ranking of said document.
